(19) United States
(12) Patent Application Publication
(10) Pub. No.: US 2005/0097146 A1
(43) Pub. Date: May 5, 2005

(54) Methods and systems for autonomously managing a network

(76) Inventors: Alexander V. Konstantinou, New York, NY (US); Yechiam Yemeni, Fort Lee, NJ (US)

Correspondence Address: WILMER CUTLER PICKERING HALE AND DORR LLP, 399 PARK AVENUE, NEW YORK, NY, 10022, US

(21) Appl. No.: 10/925,557

(22) Filed: Aug. 23, 2004

Related U.S. Application Data
(60) Provisional application No. 60/496,683, filed on Aug. 21, 2003.

(51) Int. Cl. G06F 7/00

(52) U.S. Cl. 707/200

(57) ABSTRACT

Methods and systems for autonomously managing computer networks are provided. In a preferred embodiment of the invention, management functions are organized in a novel two-layer peer-to-peer (P2P) architecture. The bottom layer organizes management information in a unified object-relationship model, that is instantiated in a distributed transactional object repository. The top layer unifies the traditional roles of managers and elements into a single autonomic management peering layer. Autonomic elements use the repository as a primary management repository, and effect autonomic behavior in terms of transactions over the shared model state. A novel autonomic policy model and language, Object Spreadsheet Language (OSL), in the form of acyclic spreadsheet change propagation rules, and declarative constraints is also provided.

### CROSS REFERENCE TO RELATED APPLICATION

The application claims the benefit under 35 U.S.C. § 119(e) of U.S. Provisional Patent Application No. 60/496,683, filed Aug. 21, 2003, which is hereby incorporated by reference herein in its entirety.

### STATEMENT REGARDING FEDERALLY SPONSORED RESEARCH OR DEVELOPMENT

The invention was made with United States Government support under DARPA contract DABT63-96-C-0088, and the United States Government may have certain rights in the invention.

### FIELD OF THE INVENTION

The present invention relates to network management systems. More particularly, the present invention relates to network management systems that autonomously manage configuration parameters

### BACKGROUND OF THE INVENTION

Autonomic computing has been proposed as an approach to reducing the cost and complexity of managing Information Technology (IT) infrastructure. An autonomic system is one that is self-configuring, self-optimizing, self-healing and self-protecting. Such a system requires minimal administration, mostly involving policy-level management. To effect such autonomic behavior, a system must instrument its operational behavior and external interactions with other systems. It needs to represent this information in a model that admits automated interpretation and control, incorporating knowledge on how to automate management actions.

Presently, systems are constructed with ad-hoc instrumentation of Managed Information Bases (MIBs) and configuration files. The information required for autonomic behavior is typically buried in design documents, operations manuals, code structures, run-time systems, and runtime environments. Management of such services involves use of proprietary management tools and protocols that have been developed to present low-level configuration and performance information to human operators. It is the responsibility of these expert operators to acquire the knowledge model needed to interpret the meaning of this information and effect configuration control. These ad-hoc forms of manageability are typically constructed a-posteriori to system design, implementation and maintenance, requiring complex adaptation in order to track system evolution.

Current configuration automation programs are typically tailored to specific features, such as propagation of DHCP leases to DNS databases, or the propagation of a new employee record into a building's security access database. These automation features may interact, causing inconsistencies and re-configuration cycles that may span administrative domains and manifest with varying periodicity. In general, it is impossible to determine apriori the interaction of programs written in Turing-complete languages. As a result, deployment of automation features is severely restricted in current environments.

### SUMMARY OF THE INVENTION

In accordance with the present invention, methods and systems for autonomously managing computer networks are provided. In a preferred embodiment of the invention, management functions are organized in a novel two-layer peer-to-peer (P2P) architecture. The bottom layer organizes management information in a unified object-relationship model, that is instantiated in a distributed transactional object repository. The top layer unifies the traditional roles of managers and elements into a single autonomic management peering layer. Autonomic elements use the repository as a primary management repository, and effect autonomic behavior in terms of transactions over the shared model state. A novel language called JSpoon is presented as a mechanism for extending element objects at design-time with management attributes and data modeling layer access primitives. JSpoon elements may be extended with additional autonomic functions at runtime using model schema plug-in extensions. A novel autonomic policy model and language, Object Spreadsheet Language (OSL), in the form of acyclic spreadsheet change propagation rules, and declarative constraints is also provided. The three variations of OSL provided by the invention express autonomic behavior as dynamic computation of element configuration over the object-relationship graph model. Static OSL analysis algorithms are provided over three incremental OSL language extensions for detecting change rule termination and performing optimal rule evaluation over any instantiation of the management model.

### BRIEF DESCRIPTION OF THE DRAWINGS

The present invention is described below in connection with the drawings, in which like reference numbers refer to like parts throughout, and in which:

FIG. 1 is a block diagram showing a two-layer architecture in accordance with certain embodiments of the present invention.

FIG. 2 is a block diagram showing a management-annotated object in accordance with certain embodiments of the present invention.

FIG. 3 is a block diagram showing a UML class diagram in accordance with certain embodiments of the present invention.

FIG. 4 is a block diagram showing a sample management schema in accordance with certain embodiments of the present invention.

FIG. 5 is a flow diagram showing iteration in accordance with certain embodiments of the present invention.

FIG. 6 is a triggering graph for Rule 2 in accordance with certain embodiments of the present invention.

FIG. 7 is a triggering graph and parse tree for Rule 4 in accordance with certain embodiments of the present invention.

FIG. 8 is a more complex triggering graph and parse tree in accordance with certain embodiments of the present invention.

FIG. 9 is a triggering graph containing a cycle in accordance with certain embodiments of the present invention.

FIG. 10 is a sample object-relationship schema in accordance with certain embodiments of the present invention.

FIG. 11 is yet another triggering graph in accordance with certain embodiments of the present invention.

FIG. 12 is an instantiation-of-class graph in accordance with certain embodiments of the present invention.

FIG. 13 is still another triggering graph in accordance with certain embodiments of the present invention.

FIG. 14 is a block diagram showing shared objects in multiple domains of a network in accordance with certain embodiments of the present invention.

FIG. 15 is a summary graph showing two domains from FIG. 14 in accordance with certain embodiments of the present invention.

### DETAILED DESCRIPTION OF THE PREFERRED EMBODIMENTS

In the following detailed description, numerous specific details are set forth regarding the methods and systems of the present invention and the environments in which the methods and systems may operate in order to provide a thorough understanding of the present invention. It will be apparent to one skilled in the art, however, that the present invention may be practiced without such specific details. In other instances, well-known components, structures and techniques have not been shown in detail to avoid unnecessarily obscuring the subject matter of the present invention. Moreover, various examples are provided to explain the operation of the present invention. It should be understood that these examples are merely illustrative and various modifications may be made in accordance with the invention. It is contemplated that there are other methods and systems that are within the scope of the present invention.

### 1. Autonomic Management Architecture

In order to support autonomic behavior, an autonomic programming architecture should satisfy certain basic requirements: (1) support the representation of element configuration and performance properties used to control and monitor element behavior; (2) express relationships between different autonomic elements; (3) control access to configuration properties to assure consistent views; (4) enable autonomic elements to discover, access and control the configuration of other dependent elements; (5) provide publish-subscribe interfaces for management event notification; and (6) enable element configuration persistence and recovery.

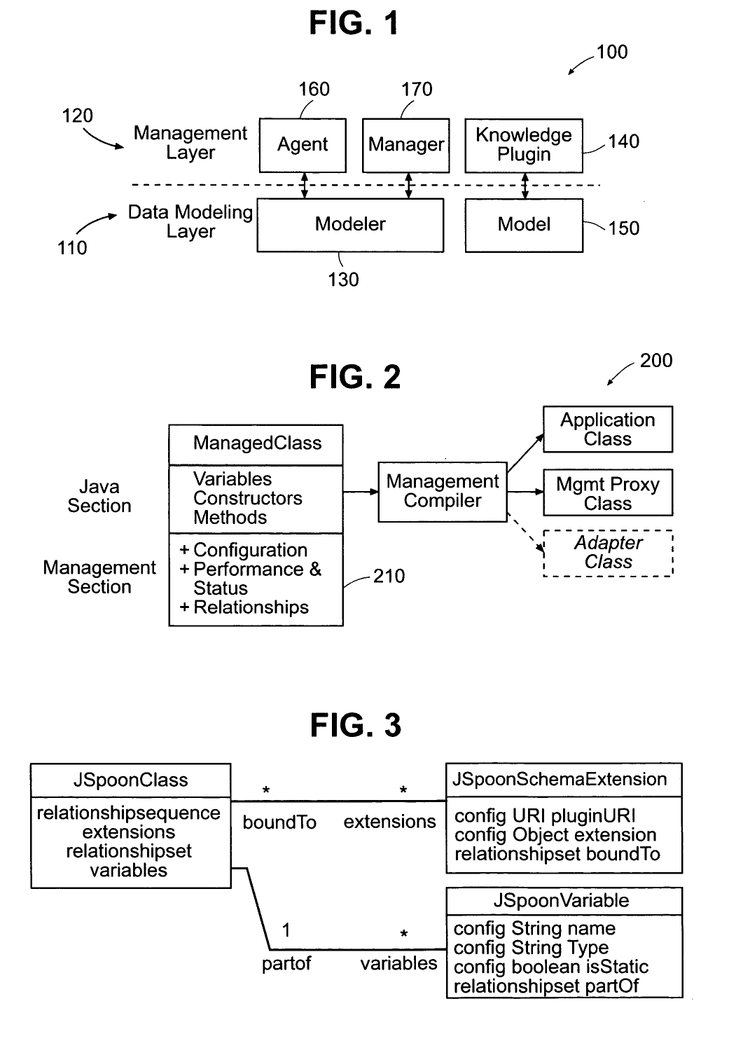

In accordance with a preferred embodiment of the present invention, autonomic systems may be organized into a two-layer architecture 100 as depicted in FIG. 1. At the bottom layer 110, Modeler 130 provides a consolidated element data repository, including configuration, relationship, state and performance attributes, as well as their behavior events. Modeler 130 also provides interfaces to access and manipulate the managed data. This enables management knowledge layer 120 to access a unified data model 150, interpret its behavior and activate autonomic control functions. Knowledge layer 120 supports representation of the data model semantics and encoding of domain-specific knowledge. Two-layer architecture 100 preferably does not distinguish among elements, agents 160 and managers 170 in terms of access. The element, agent, and manager roles are implemented by programs that manipulate the data model stored in the modeler and may incorporate instrumentation and manipulation models of their own using the JSpoon programming language (or any other suitable language) as described below.

Modeler 130 may be embodied in software executed on a management server on managed network, for example, and the programs that implement the element, agent, and manager roles performed in knowledge layer 120 may be executed on any suitable equipment that is part of the managed network, for example, servers, routers, firewalls, clients, etc. Obviously, any suitable hardware and/or software for performing the functions described herein may be used to implement the present invention.

Autonomic management instrumentation variables can be assigned to one of four basic categories, with associated access patterns: 1) Configuration properties, which control the behavior of the autonomic element and therefore should be protected in regards to concurrency and semantic content; 2) Performance properties, which export element performance measurements and operational state, preferably cannot be locked, and may only be set by the element owning the object; 3) Relationships, which express dependencies to other autonomic elements; and4) Event data which indicate operational states such as status, exceptions or performance conditions.

This is described in further detail in A. Dupuy, S. Sengupta, O. Wolfson, and Y. Yemini, “Netmate: A network management environment.” IEEE Network Magazine (special issue on network operations and management), 1991, and A. Schade, P. Trommler, and M. Kaiserswerth, “Object instrumentation for distributed applications management,” In IFIP/IEEE International Conference on Distributed Platforms, pages 173-185, 1996, both of which are hereby incorporated by reference herein in their entirety.

Based on these access patterns, a restricted instrumentation declaration language that can automate the creation of object management instrumentation, and support composable configuration semantics has been developed in accordance with the present invention. FIG. 2 depicts a management-annotated object 200 whose class declaration is extended with an additional management section 210.

In the two-layered architecture 100 of FIG. 1, Modeler 130 acts as the management data and schema repository. In one embodiment, the Modeler activates instrumentation to discover elements in its network environment and their relationships by reading data from element or management components. The Modeler uses this data to construct and maintain an internal object-relationship repository model, using schema libraries. This internal model is exported to autonomous applications, whether managers, element agents, analysis programs, automated configuration management software or other autonomous management components wishing to access the Modeler.

Access to Modeler 130 should be controlled to maintain consistency and support recovery in case of failure. The Modeler provides object life cycle management, distributed transaction coordination, and object persistence services. Preferably, autonomic elements use a common language, JSpoon (described below), for accessing these modeler functions. This language-based approach simplifies element implementation, and enables compile-time checks, and optimizations.

Autonomic management architecture 100 also supports extensibility of the instrumentation schema language through the use of knowledge modules 140. Knowledge modules 140 enhance the instrumentation data model with semantic information. For example, a fault-management plug-in can add a language for expressing propagation of problems over relationships in order to support codebook event correlation. See SMARTS, “MODEL Language Reference Manual,” 1996 and Yemini et al. U.S. Pat. No. 6,249,755, issued Jul. 19, 2001, both of which are hereby incorporated by reference herein in their entirety. Similarly, a configuration automation system may support a language for expressing configuration constraints and change propagation rules that are maintained by a rule interpreter. See Y. Yemini, A. Konstantinou, and D. Florissi, “NESTOR: An architecture for NEtwork Self-managemenT and Organization,” IEEE JSAC, 18(5), 2000, which is hereby incorporated by reference herein in its entirety.

### 2. The JSpoon Language

As illustrated below, the present invention may be implemented using “JSpoon,” which is an extension of the Java language. Obviously, the present invention may be implemented using any suitable language that can provide similar functionality to that set forth herein and as recited by the claims.

Generally speaking, “JSpoon” is a language and runtime environment for integrating data modeling layer access into Java-based managed services and managers. The JSpoon language extends Java with declarations of management class and instance variables, as well as event subscription and atomicity primitives. The JSpoon runtime environment is responsible for supporting persistence, synchronization, remote access, and knowledge plug-in services.

The set of variables declared in JSpoon forms the management section of the Java object, which is exported to other JSpoon programs. There are two types of JSpoon variables: 1) configuration variables; and 2) performance variables. Configuration variables are used to control program behavior, whereas performance variables instrument program status. Configuration variables may be persisted across Java Virtual Machine (VM) invocations. Access to the configuration variables is controlled by the JSpoon runtime environment to support transaction semantics. Atomic access is expressed using the JSpoon language locking constructs. In contrast, performance variables may only be updated by the owner of the object, are not persistent, and may not be accessed transactionally.

The following is an example of a JSpoon object class:

```
public class NtpServer extends Thread {
  protected DatagramSocket sock;
  config key int port = 123;
  config boolean active = true;
  instrument counter long reqCount = 0;
  public NtpServer( ) throws ... {
    sock = new DatagramSocket(port);
  }
  public void run( ) {
    while(active) {
      sock.receive(packet);
      reqCount++;
      // process request ...
    }
  }
}
```

The class implements a Simple Network Time Service (SNTP). See D. Mills, “Simple Network Time Protocol (sntp),” Technical Report RFC 2030, IETF, 1996, which is hereby incorporated by reference herein in its entirety. SNTP is a UDP-based protocol for querying time servers over an Internet Protocol network. As illustrated in this code fragment, the SNTP service implementation is written in standard Java extended with JSpoon declarations. The class encapsulates a regular Java instance variable called “sock” which maintains the server's UDP binding. In addition, three management instance variables are declared in the extended syntax of JSpoon: “port” and “active” (configuration), as well as “reqcount” (performance).

The “port” instance variable stores the NTP service UDP port number, and is a configuration variable, as identified by the JSpoon modifier “config,” of primitive type “int” initialized to the default SNTP UDP port 123. The “key” variable states that the value must be unique in all instances of the class within the Java VM. The second configuration instance variable, “active,” controls termination of the server process. The “reqcount” performance variable, as identified by the “instrument” modifier, counts the number of time queries received.

From the service's perspective, the declaration and usage of JSpoon management variables is similar to that of regular Java variables. There are two main differences: 1) management variables are exported through the JSpoon runtime environment to external management processes; and 2) the types of operations permitted on the management variables may be restricted based on the JSpoon modifiers. For example, an external manager may change the value of the “active” configuration property, thereby effecting termination of the service. Similarly, the operations allowed on the “reqcount” “counter” performance variable are restricted to monotonically increasing value updates.

2.1 JSpoon Modifiers

JSpoon configuration and performance variable declarations may be specialized with the modifiers listed below:

| Modifier | To | Description |
|---|---|---|
| Computed | i | Evaluate on-demand; not stored |
| Counter | i | Monotonically increasing value |
| Final | c | Assign-once (Java semantics) |
| Key | c | Unique object identifier |
| Static | c, i | Property of class; not instance |
| Transient | c | Non-persistent variable |

JSpoon modifiers may only be applied to class (c) and instance (i) variable declarations. The JSpoon compiler will generate a syntax error if JSpoon modifiers are used in other contexts, such as in method argument or variable declarations.

“Computed” variables have their value evaluated on-demand using a Java expression. For example, the computed free memory performance variable shown below is associated with a Java expression for obtaining the free memory in the Java VM:
instrument computed long freeMemory=Runtime.getRuntime( ).freeMemory( );
   Computed variable expressions are bound to the scope of their declaration.

Numeric performance JSpoon variables marked with “counter” are restricted to a monotonically increasing value. The counter marker may be applied to the primitive number types, and objects implementing the “java.lang.Comparable” interface. The only operations permitted on primitive numeric types are “++” (increment by one), and “+=” (increment by value, where value >=0). Numeric object types are immutable, therefore the only allowed operation is assignment (=) where the assigned value compares-to greater, or equal to the previous value.

Configuration variables may be marked as “final” to specify that they may only be assigned once and cannot be modified by the program or an external entity. It is possible to change persistent final variables in between program invocations. Typically, variables will be declared final if the program is not able to adjust its behavior after startup. For example, the user ID under which a Java process should be executed may be declared as a final variable.

Certain configuration variables may uniquely identify an object instance. For example, in the JSpoon object class example of a Simple Network Time Service described above, the port variable is defined as a “key” variable since only a single instance of “NtpServer” can bind to the same unicast UDP port. When multiple configuration variables are declared as keys, their combination uniquely identifies the object.

The “static” JSpoon modifier associates its configuration or performance variable with the enclosing class, not an instance as is the default.

Configuration variables may be marked “transient” to indicate that the JSpoon runtime should not maintain their values across Java VM invocations, or when the object is serialized. Persistence requires additional changes in the way Java programs manage the life-cycle of their objects, and is covered below. By default, all configuration variables are persistent. Instrument variables are always transient, and can only be persisted through explicit assignment to a configuration variable.

Unlike Java class and instance variables, JSpoon variables are not associated with an access modifier such as “public,” “protected,” or “private.” All JSpoon variables are publicly accessible via the JSpoon runtime. A role-based security policy may be configured at the modeler-layer, or through a security-knowledge plug-in, if desired.

2.2 JSpoon Types

JSpoon variables are strongly typed in the Java type system. All Java primitive types are allowed in JSpoon variable declarations. Java object types may be used if, and only if, they represent immutable objects, and are serializable. Since there is no Java marker interface identifying objects as immutable, the JSpoon compiler includes a list of immutable standard Java library object classes. User-defined classes employed in JSpoon variable declarations must implement the “jspoon.Immutable” marker interface and all their non-JSpoon variables must be declared as “final.”

JSpoon extends the Java type declaration system with support for enumeration types. An example of an enumeration declaration of the type “Status” with two enumerated values is shown below:

```
enum Status { stopped, running };
instrument Status status;
public void method( ) {
  status = Status.stopped;
  // ...
  if (status == Status.running) ...
}
```

An enumeration type is conceptually mapped into a Java inner class of the same name, with immutable instances for each enumeration value. These instances are available as static final variables of the enumeration class. As shown in the example, an enumeration variable may be assigned or compared for reference equality with the static enumeration instances.

JSpoon relationship declarations are used to establish an association between two Java objects. Unlike simple references, relationships can be navigated in both directions. Each end-point in the binary association is associated with a role (variable identifier), and multiplicity (to-one, to-many-set, or to-many-sequence).

A sample relationship declaration is shown below:

```
public class HttpServer
  extends Thread {
  relationshipset threads, HttpThread,
        serves;
  public void run( ) {
    while(true) {
        Socket s = sock.accept( );
        threads.add(new HttpThread(s));
    }
  }
}
public class HttpThread
  extends Thread {
  relationship serves, HttpServer,
      threads;
  public void run( ) {
    // Process HTTP request ...
    serves = null;
  }
}
```

Instances of the class “HttpServer” are associated with a set of “HttpThread” objects through the “threads” variable role. The same relationship must also be declared in the “HttpThread” class, with the role names reversed. In this case, the “serves” variable role is declared with a to-one multiplicity. Variables identifying to-one relationship roles may be used as normal Java object reference variable. To-many relationship variables support accessor methods for retrieving, adding, removing and setting their membership.

2.3 JSpoon Events

JSpoon programs may subscribe to receive notification of modeler events. The modeler generates six basic types of events: 1) class “load”; 2) class “unload”; 3) “create” object; 4) “delete” object; 5) attribute “get”; and 6) attribute “set.”

JSpoon supports event subscriptions as a language construct. The “subscribe” keyword takes an event condition expression as its first argument, executing an associated statement when a matching event is found. An optional event declarator may be provided if the contents of the matching event need to be processed within the statement. Subscriptions return a JSpoon lease object used to manage their life-cycle.

Two event subscription examples are shown below:

```
JSpoonLease lease =
  subscribe evt:
      (NtpServer.port != 123) {
        evt.object.active = false;
}
NtpServer mySrv = ...;
lease = subscribe
  ( (mySrv.port == 123) &&
    (! mySrv.active) ) {
    mySrv.active = true
}
```

The first subscription matches assignment of “NtpServer” port instance variables to non-standard SNTP ports. The event handler terminates the SNTP service by setting its “active” attribute to false, by retrieving the object reference from the event object. The JSpoon compiler employs type-inference to determine that the enclosed object will be of type “NtpServer,” thereby saving the need for an explicit cast. JSpoon programs may also subscribe for events on specific object instances, as is shown in the second example.

Basic events are associated with a type (load, unload, etc.) which may be queried using the “type” attribute. Other event attributes include “object” (object), “transactionID” (source), and “value.”

2.4 Atomic Operations

JSpoon expresses concurrency control similarly to the way that Java handles thread synchronization on object methods and variables. JSpoon programs requiring atomic access to multiple configuration attributes must perform these accesses within an “atomic” block. The atomic block provides JSpoon programs with atomicity, consistency, isolation, and durability (for persistent properties) in accessing management attributes.

An atomic block example is shown below:

atomic(lock-timeout) {
z = x + y;
}

The JSpoon program encloses its access to the configuration properties “x,” “y,” and “z” in a “atomic” block to assure consistent change. The JSpoon runtime will generate the required read lock requests for “x” and “y,” as well as a write lock request for “z.”

The obtained locks are owned by the thread-of-execution. Nested transactions are supported through syntactically nested blocks, or through invocation of methods containing atomic blocks. The effected changes are committed at the end of the block, and the acquired locks are released, unless this is a nested transaction.

Lock requests may fail due to a communications failure, detection of a dead lock, or lock acquisition timeout. These errors are signaled in the form of exceptions. If an exception is thrown in an atomic block, then the values of all “management” configuration attributes will be restored to their previous values. The syntax of the atomic block supports the optional specification of a lock acquisition timeout.

Atomic blocks may also be used to group the generation of performance variable update events. Performance variable updates performed within an atomic block do not generate modeler update events until the end of the block. This mechanism may be used to provide consistent views of performance variables and to reduce the overhead of synchronization between the service thread and the JSpoon event monitoring thread.

2.5 The JSpoon Runtime Environment

The JSpoon runtime environment is responsible for providing object life-cycle services, and exporting management information to remote management processes. Managed object persistence, synchronization, remote access and event generation services are discussed below.

2.5.1 Persistence

The JSpoon runtime environment supports persistence of object configuration variables. In order to enable persistence, classes must implement the “Persistent” marker interface. Persistent objects must be assigned a unique object identifier (OID) in order to support retrieval when instantiated within the Java program. Objects which have key variables, all of which are final and persistent, can be automatically assigned a unique OID. In all other cases, the programmer is responsible for assigning the unique OID.

The JSpoon compiler modifies the signature of persistent class constructors to include an additional argument of type “jspoon.JSpoonOID” and to throw the “Persistence-Exception” exception. The constructors are also modified to include the necessary hooks for retrieving previously persistent variable values. It should be noted that the persistent values will override any default variable values specified in the declaration section. At construction time, the programmer must provide the additional OID parameter to establish the unique identity of the object.

The “NtpServer” class after it has been marked to support persistence, and a simple “TimeDaemon” application which uses a single instance of the “NtpServer” class, are shown below:

```
public class NtpServer extends Thread
  implements jspoon.Persistent {
  // ...
}
public class TimeDaemon {
  public static void main(...) {
    JSpoonOID oid = new JSpoonOID
      (“jspoon:NtpServer#Singleton”);
    NtpServer srv =
      new NtpServer(oid);
  }
}
```

At construction time, the additional OID argument must be provided to establish the object's identity. A static identifier can be used in this case because the application is limited to creating a single instance of the persistent class.

Every JSpoon process must be assigned a unique service identity (SID). Service IDs are required in order to prevent multiple instances of a program from owning the same persistence repository data. Persistence repositories must support locking to prevent concurrent binding of multiple JSpoon programs using the same SID. A lease-based mechanism is employed to support releasing of resources following a service failure.

A fully qualified object ID contains the service ID as well as the location of its persistent repository. It is possible to set the default service ID and repository location of a JSpoon process in order to simplify construction of OID objects. Services can have multiple SIDs and connect to multiple persistence repositories.

An object ID may be represented as a URI (See T. Berners-Lee, R. Fielding, U. Irvine, and L. Masinter, “Uniform Resource Iidentifiers (URI): Generic syntax,” Technical Report RFC 2396, IETF, 1988, which is hereby incorporated by reference herein in its entirety) of the form:
jspoon://userinfo@host:port/serviceID#OID

For persistent objects with final key attributes the OID) may be expressed as:
className?key1=value1,key2=value2 . . .

The Java language supports objects serialization as a mechanism for storing and transmitting object state. The JSpoon compiler modifies the “writeObject” and “readObject” methods of serializable objects to include marshaling and unmarshaling of variables in the management section, and code for binding the deserialized object into the local JSpoon runtime environment.

2.5.2 Synchronizing States

JSpoon class configuration variables may be changed by remote managers. A change in the configuration variable will be reflected in program behavior at the next point at which this variable is read. For example, the “active” variable in the program of the Simple Network Timer Service JSpoon Object Class example above is consulted every time a request is serviced. If the server is idle, then it will remain blocked on the socket “receives( )” method, and will not terminate until a datagram has been received and processed. In order to increase responsiveness, the program may set a socket timeout to establish an upper bound on its delay to respond to a change in the “active” configuration.

The JSpoon runtime environment monitors application access to configuration variables, and can detect if the program has failed to read a changed configuration value after a certain period. Based on its configuration, the environment can elect to restart the server. Since the Java VM does not support external thread termination (kill), it is recommended that JSpoon program threads consult the static “jspoon.JSpoonThread.terminate” boolean variable, and cleanly terminate execution when it has been set to true.

There are cases in which configuration variables are consulted only at program startup. Examples include network service port numbers, persistent storage directories, and others. To support dynamic reconfiguration, programs should embed explicit synchronization code. For example, the main loop of the Simple Network Timer Service JSpoon Object Class example above can be rewritten as:

```
while(active) {
  sock.receive(packet);
  if (port != sock.getLocalPort( )) {
    // close & reopen socket
  }
}
```

2.5.3 Remote Access

JSpoon programs requiring access to management attributes of remote objects must first obtain a local copy (view). This is performed by using the static methods of the “jspoon.JspoonNaming” class. The “list” method supports query of objects based on a query URI. In the example below, the manager requests the OIDs of all instances of the “NtpServer” class:

```
public class NtpMonitor {
  public static void main(...)
    throws ... {
    JSpoonOID[ ] oids =
      jspoon.JSpoonNaming.list
      (“jspoon://localhost/NtpServer”);
    NtpServer server = (NtpServer)
      jspoon.JSpoonNaming.lookup
      (oids[0]);
    while(true) {
      System.out.println
      (server.reqCount);
      Thread.sleep(5000);
    }
  }
}
```

The example code assumes that at least one OID is returned, and then invokes the lookup method to obtain a local view of the JSpoon object. Subsequently, the JSpoon object can be accessed in the manner illustrated in previous examples.

If the listing and lookup methods are enclosed in an atomic block, the JSpoon runtime will obtain appropriate locks to assure that the results remain stable. In the listed example, had the listing and lookup methods been enclosed in an atomic block, the runtime would lock “NtpServer” object creation and remove effects.

2.5.4 Managed Java Library Objects

The JSpoon environment provides managed versions of standard Java library objects. JSpoon managed objects follow a naming convention of appending the jspoon prefix to the full class name of the instrumented class. In this manner, the “jspoon.net.JspoonDatagramSocket” class supports configuration and performance instrumentation of UDP datagram sockets. Use of managed objects can greatly increase the management flexibility of Java programs. For example, use of the managed socket class in the “NtpServer” would enable managers to configure socket options such as the traffic class.

2.5.5 Introspection & Knowledge Plug-ins

Knowledge plug-ins extend the capabilities of the basic JSpoon schema. For example, a simple constraint knowledge plug-in may add support for type range restrictions. A JSpoon autonomic element may use this plug-in to further restrict the values of port number configuration attribute to the range [1024 . . . 65535].

JSpoon knowledge plug-ins are enabled in the form of schema extensions to JSpoon classes. The schema of a JSpoon class is represented with a meta-object that is also a persistent JSpoon class of type “JSpoonClass.” “JspoonClass” defines a to-sequence relationship to instances of the JSpoon class “JSpoonSchemaExtension.” Schema extensions consist of a knowledge plugin URI and an opaque object. A schema extension may be bound to multiple instances of “JSpoonClass.” A UML class diagram 300 showing parts of the JSpoon meta-schema classes is shown in FIG. 3.

When the JSpoon runtime environment loads a JSpoon class, it attempts to retrieve the class meta-object from persistent storage. The schema extension relationship of the meta-object is queried and the runtime environment attempts to download any knowledge module proxy plug-ins that are not already installed based on the URI. This capability depends on the Java cross-platform and security features. Runtime changes to the meta-object schema extension relationship can also trigger the loading or unloading of knowledge plug-ins.

At load-time, plug-ins use the JSpoon runtime event subscription API to request notification of object management events. Plug-in subscriptions provide synchronous notification of pending changes, enabling the knowledge module to abort invalid changes. Plug-ins receive two additional events triggered by the creation and closing of a transaction, or nested transaction. These events enable evaluation of postconditions.

The knowledge schema extension mechanism is very powerful, but may introduce cyclical computations. A cyclical computation may be triggered by the interaction of two knowledge plug-in modules that propagate changes. Because the periodicity of the cycle may be very large, it may be impossible to identify in a reasonable time. Therefore, in absence of additional information on propagation paths, the JSpoon runtime system defines a maximum knowledge module iteration count.

2.5.6 JSpoon Compilation

JSpoon-enhanced classes are compiled into Java VM bytecode class files. The language was designed to support JSpoon-to-Java source-to-source compilation as an intermediate step. The JSpoon compiler generates two identically named Java classes for every JSpoon class. The element class contains both the management and non-management sections. The management class contains only the management variables and is used by remote elements. Both classes depend on the JSpoon runtime for view maintenance.

Management variable accesses by JSpoon programs are transformed into corresponding accessor methods. Lefthand-side (assignment) updates and right-hand-side reads are replaced by “set” and “get” method invocations. The actual management attributes are declared as private transient Java instance variables with mangled names. Configuration variable accessors invoke JSpoon runtime methods for locking and logging. Performance variable accessors invoke JSpoon event generation methods. A static block is also created to notify the runtime of a class-loading event.

Atomic blocks are compiled into JSpoon runtime environment method invocations to create a transaction (potentially nested), commit the transaction at the end of the block, or abort if an exception has been thrown. The JSpoon compiler attempts to optimize lock acquisition through static code analysis to batch lock requests, and minimize lock upgrades. Batched lock requests are sorted by object ID to reduce the likelihood of deadlock. If the compiler can determine that an atomic block does not include access to configuration attributes, then no transaction is generated, only the events are batched.

The JSpoon compiler may optionally generate proxy objects for exporting the management schema to existing Java and XML-based persistence and management APIs and protocols. For example, the compiler may generate MBean objects conforming to the JMX (See Sun Microsystems, “Java Management eXtensions instrumentation and agent specification (v.1.2),” Technical report, 2002, which is hereby incorporated by reference herein in its entirety) architecture to support interaction with JMX managers. The compiler may also generate an XML schema, and protocol proxy for XML management standards such as XMLCONF (See R. Enns, “XMLCONF Configuration Protocol,” Technical Report draft-enns-xmlconf-spec-00, IETF, 2003, which is hereby incorporated by reference herein in its entirety).

### 3 Object-Relationship Model

The JSpoon management schema language described above extends the Java language with additional class management methods, attributes, and relationships. The management view of a JSpoon program consists of the JSpoon class, management method, attribute, and relationships. This management view does not contain non-management method declarations or non-management attribute declarations. The change propagation and policy languages introduced below refer to the management view of JSpoon classes. The management schema expresses the following object-oriented features (See K. Arnold, J. Gosling, and D. Holmes, “The Java Programming Language,” The Java Series, Addison-Wesley, 3rd ed., 2000, and L. Cardelli, “Typeful programming,” in Formal Description of Programming Concepts, Springer-Verlang, 1989, which is hereby incorporated by reference herein in its entirety):
1) Classes: define the structure of objects, the mechanisms for construction, the encapsulation data attributes, and the executable methods encoding class behavior (implementation).
2) Types (interfaces): define abstract types in the form of a collection of methods without reference to a specific implementation. JSpoon interface declarations may include management method, attribute, and relationship declarations.
3) Inheritance: a management class or interface may extend another management class or interface (parent). The extension class (subclass) inherits the parent's management methods, attributes and relationships. A subclass may be used wherever the parent class is expected. Management subclasses may provide additional management methods, attributes, and relationships declarations, or override existing ones. JSpoon supports single-inheritance only.
4) Implementation: a management class may implement the specification of one or more types (interfaces). The management class must provide implementations for all management methods declared in the implemented interfaces.
5) Attributes: management attributes may be declared as configuration or performance attributes, defining their patterns of use. Additional modifiers may further restrict the types of supported operations. Management attributes must be of primitive, immutable Java object, or JSpoon management object type.
6) Relationships: define typed bi-directional pointers between management classes, or interfaces. Each end-point of a relationship must be named, and the cardinality of its target class must be declared as to-one, to-set, or to-sequence.
7) Management methods: encapsulate access to management attributes and are restricted to accessing management methods, attributes and relationships.

The above JSpoon object-relationship model will form the data model over which propagation rules will be defined.

### 4 Management Schema Example

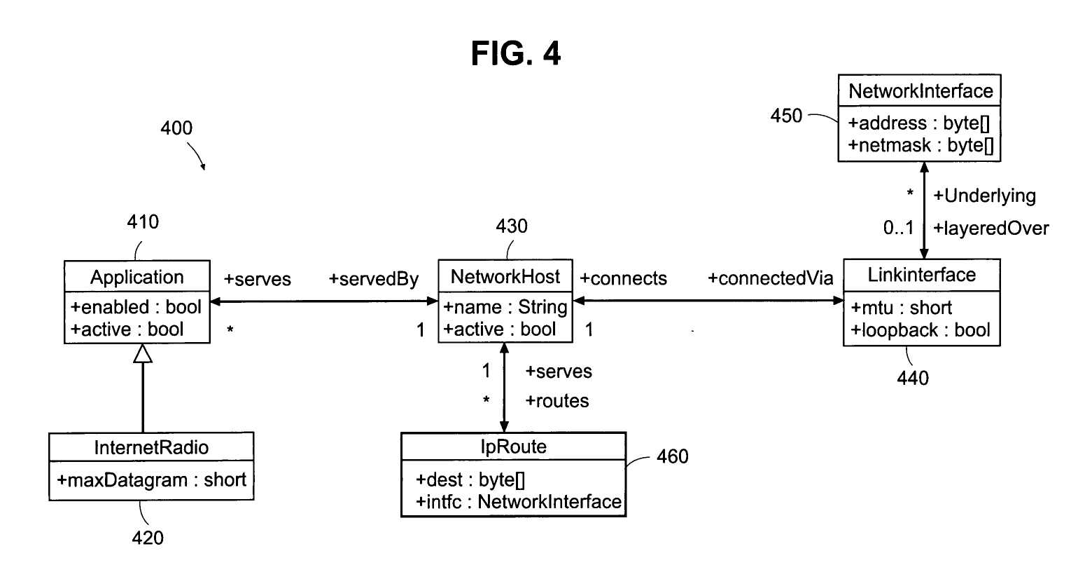

The change propagation and policy languages presented herein are illustrated using a common management schema example. The sample management schema 400 is illustrated in FIG. 4 using the notation of UML (See OMG, “Unified Modeling Language (UML),” tech. rep., Object Management Group (OMG), 1997, which is hereby incorporated by reference herein in its entirety). It was chosen to include all of the core JSpoon management schema features. It should be noted that the example was selected with the goal of providing a minimal schema illustrating available features, and is not intended to represent an actual unified configuration model.

Sample schema 400 declares an “Application” class 410 containing two boolean management attributes. The “enabled” attribute controls the operation of the application, while the “active” attribute monitors the status of the application. A subclass of the “Application” class is used to define an “Internet radio” service 420 with an attribute controlling the maximum size of the broadcast datagrams. The “Application” class is related in a many-to-one relationship to a “NetworkHost” class 430, which acts as its host. In a similar manner, the “NetworkHost” class is related to a “Linklnterface” class 440 that encapsulates a link-layer network interface. Multiple network interfaces can be layered over a link interface as “Networklnterface” 450 instances. Finally, the network host has an associated routing table that is modeled as a to-many relationship to “IpRoute” object instances 460.

### 5 Expressing Object-Relationship Change Propagation

In the object-relationship model, configuration and performance properties are expressed as typed class attributes, while dependencies are expressed as binary relationships between classes. A change propagation language operating over an object-relationship model must support navigation of the schema features, and define the semantics of these operations.

For example, a UDP-based Internet radio application depends on the ability of the network to transmit datagrams to its listeners. If the size of the datagrams exceeds the network's Maximum Transfer Unit (MTU), they may be fragmented or dropped. Therefore, it is useful to define a rule that propagates the network's MTU to the configuration of the service's datagram size. All the required information is available in the unified object-relationship model. While it is possible to use a general purpose programming language, such as Java, to access and manipulate the model, such programs cannot be analyzed for interaction with other automation programs.

In particular, an autonomous system needs to guarantee the safety of change propagation. For example, should change propagation rules result in a loop the system may enter a livelock-mode where it oscillates between configuration changes endlessly. Similarly, should change propagation rules result in an ambiguity—whereby a change may activate two independent sets of successive rules leading to different changes in a given element configuration—then the system may enter unpredictable and possibly inconsistent configuration modes. A general-purpose language would allow programming rules leading to unsafe operational modes, such as loops or ambiguities. Furthermore, the task of detecting these unsafe modes through static compile-time analysis of the rules is in general undecidable and may require restricting the structure of rules in a manner that is difficult for programmers to control.

Therefore, the approach developed by this invention is to provide restricted languages for coding change rules, such that any rules coded in these languages may be validated for safety features, such as freedom from loops or ambiguities, by analyzing the rules codes. Thus, the safety of an autonomous systems programmed in such languages may be supported through automated compiler tools.

Three increasingly powerful Spreadsheet Object Languages (OSL) for expressing such propagation of changes are introduced below. As will be discussed, each increase in expressive power effects the analysis and evaluation of rules expressed in each language. All languages share the fact that they are strongly typed, against the JSpoon type model, and define spreadsheet rules that propagate the result of evaluating an expression into a class attribute or relationship.

The syntax of OSL is derived from the syntax of the Object Constraint Language (OCL) (See OMG, “Object Constraint Language specification (OCL),” Tech. Rep. ad/97-08-08 (version 1.1), Object Management Group (OMG), September 1, 1997, which is hereby incorporated by reference herein in its entirety), which itself is derived from the syntax of SmallTalk.

5.0.1 OSL Types

As stated above, OSL is a strongly typed expression language over the JSpoon type system. OSL₀ expressions may access and manipulate JSpoon configuration attributes, and relationships. OSL supports static type-checking of expressions (See Y. Leontiev, M. T. Ozsu, and D. Szafron, “On type systems for object-oriented database programming languages,” ACM Computing Surveys (CSUR), vol. 34, no. 4, pp. 409 449, 2002, which is hereby incorporated by reference herein in its entirety). The following JSpoon types may be manipulated:
1) Primitive types: the standard Java language primitive types (boolean, byte, char, short, int, long, float, double). In addition, OSL defines a string primitive type which represents an immutable Unicode string without support for the Java String objects operations. The three languages provide increasingly powerful operations on these primitive types.
2) Java immutable classes: Java library classes representing immutable objects, whose state cannot be modified past construction time, may be accessed. Such objects can only be compared for equality and no methods may be invoked on them.
3) JSpoon objects: JSpoon objects may be used as types of configuration attributes or as endpoints in a relationship. Only the management section attributes and relationships are visible. No Java methods may be invoked on such objects.

5.0.2 Evaluation Semantics

Every OSL propagation rule is of the form “c.t :=e(o),” where t is an attribute or relationship of class c, and e is a side-effect free expression over object o which is an instance of c. The operations supported in the expression component are defined by the successive OSL languages. It is safe to evaluate the expression e(o) any number of times, since its evaluation cannot effect the state of the model. The only side-effect possible in OSL is through the assignment operation “:=”. In this sense, the spreadsheet model is a hybrid of the declarative and imperative programming styles (See R. W. Sebesta, “Concepts of Programming Languages,” Addison-Wesley, 3rd ed., 1996, which is hereby incorporated by reference herein in its entirety).

Only one rule for each class attribute or relationship may be declared in OSL. This restriction assures that the rule evaluation order does not affect the final propagation state.

Unlike traditional Event-Condition-Action (ECA) systems, the semantics of OSL evaluation state that every formula is re-evaluated on every instance after every model change. The following propagation algorithm is invoked whenever a change occurs on the instantiation of the object-relationship model:

```
on (external change to field f of object o of class c on transaction t) do
  m <- true
  while(m) do
    m <- false
    for (each rule r) do
      for (each instance o' of rule's target class c) do
        if o' ≠ e(o) then
          o'.f <- e(o')
          m <- true
```

There are four types of possible changes that can be performed on an instance of the model: 1) attribute modified: the value must be propagated by computing every formula in which it is used; 2) relationship modified: new propagation paths may be created, and formulas depending on the state of the relationship will have to be evaluated; 3) object created: the value of each attribute and relation that is the target of a rule needs to be evaluated, and a change in one field may result in changes to the same, or other objects; and 4) object removed: the object is removed from any relationships in which it participates, and the formulas operating over these relationships are evaluated.

If cyclical rule declarations, such as “c.x:=y” and “c.y:=x” are permitted, then the loop may never terminate. It will be shown that the OSL spreadsheet languages can be analyzed statically for termination, and that the evaluation of an acyclic set of OSL rules will always terminate. An incremental algorithm will be demonstrated in which a formula is evaluated incrementally when its expression components change.

5.1 OSL₀ Arithmetic Expression Language

The simplest form of change propagation language is one allowing the propagation of values over the object-relationship model without conditional statements and quantification.

5.1.1 Operations

OSL₀ restricts the types of operations that may be performed on values. Primitive boolean types can be compared for equality. Negation and not-equals follow from boolean equality as shown in the table below:

| Operation | Notation | Equivalent | Result Type |
|---|---|---|---|
| equals | a = b | | Boolean |
| negation | not a | a = false | Boolean |
| not equals | a <> b | not (a = b) | Boolean |

Binary boolean operators, such as “and,” “or,” and “xor” are not available in OSL₀. Primitive arithmetic types may be compared for equality and inequality, added, subtracted, divided and multiplied. Negation and not-equals follow from these operations as shown in the table below:

| Operation | Notation | Equivalent | Result Type |
|---|---|---|---|
| equals | a = b | | Boolean |
| addition | a + b | | Number |
| subtraction | a − b | | Number |
| multiplication | a * b | | Number |
| division | a/b | | Number |
| less | a < b | | Boolean |
| less or equal | a <= b | | Boolean |
| more | a > b | not (a <= b) | Boolean |
| more or equal | a >= b | not (a < b) | Boolean |
| not equals | a <> b | not (a = b) | Boolean |
| negation | −b | 0 − b | Number |

Division introduces the possibility of undefined results. The default operator, which is introduced below, may be used as an exception handling mechanism.

Java objects may only be compared for reference equality. No methods may be invoked on such objects. JSpoon object configuration attributes and relationships can be accessed, but none of their Java methods may be invoked.

5.1.2 Attribute Assignment

A language for automating change propagation in an object-relationship model must, at a minimum, support the setting of object attributes. The expression below states that the “mtu” configuration attribute of all instances of class “IntemetRadio” is assigned the constant value “508.” The “context” statement defines the class scope.
Rule 1: context IntemetRadio:mtu:=508
   Class attributes may also be assigned values from other class attributes of the same instance. For example, the “active” performance attribute is assigned the current value of the “enabled” configuration attribute in the expression below:
Rule 2: context Application:active:=enabled

The semantics of assignment in OSL are different from that of assignment in imperative languages, such as Java. An OSL assignment expression is a constraint on the value of an attribute. It states that whenever the class attribute is accessed, its value will be equal to the result of evaluating the right-hand-side expression (like when a cell in a spreadsheet having a formula therein is evaluated). Note that this specification allows for lazy evaluation of OSL rules.

Only a single assignment statement may be defined for each object class attribute. The OSL runtime system will not allow multiple assignments to the same attribute.

5.1.3 Navigating Relationships

The source of configuration values may include other objects that are reachable via relationships. In the expression below, the “active” property is assigned the value of the “active” property of the “NetworkHost” object related to the “Application” object through the to-one “servedBy” relation. The dot “.” operation is used to access the “active” property of the object in the “servedBy” relation.
Rule 3: context Application:active:=servedBy.active

Because “servedBy” is a to-one relationship, the result of dereferencing it will be either a single instance of “NetworkHost,” or null. The previous rule will therefore be undefined when applied to an “Application” instance that is not related to a “NetworkHost” instance.

OSL requires that assignment expressions must always be defined. An exception handling mechanism is provided to handle null relationship dereferencing events. In the expression below, the active property is set as before, but if a null relationship is navigated, then the “default” value of “false” is assigned. All rules navigating to-one relationships must provide such handlers.
Rule 4: context Application:active:=servedBy.active default false

5.1.4 Collection Types

Navigation of to-many relationships requires the introduction of collection types. The management schema language supports the declaration of two types of to-many relationships: to-set and to-sequence. The result of navigating a to-set or a to-sequence relationship will be a set, or a list respectively. Collections are immutable and are parameterized by the type of the relationship endpoint. In the OSL₀ assignment language, only four collection operations are supported as listed in the table below:

| Operation | Result | Description |
|---|---|---|
| size( ) | Int | number of elements |
| isEmpty( ) | Boolean | true if collection is empty (size = 0) |
| toArray( ) | Type[ ] | returns elements as array of Type |
| collect (name) | Collection | collects an attribute or relation from |
| | | each element |

The next expression shows an example rule for setting the active property of the “NetworkHost” class to be true if the host is connected to one or more link interfaces. The “connectedVia” relationship is a to-set relationship, and therefore evaluates to a value of type “Set<LinkInterface>”. In order to improve readability, collection operations use the arrow “→” operator, instead of the dot “.” operator.
Rule 5: context NetworkHost:active:=not connectedVia→isEmpty( )
   Collection types support the grouping of attributes or relations. For example, if the “NetworkHost” class had a “byte[][]” addresses property, we could express a propagation rule that navigated the “connectedVia” relation to obtain a set of “Linkinterface” objects, and then navigate the “layeredOver” to-one relation to collect the network interface address of each link interface.
Rule 6: context NetworkHost: addresses:=ConnectedVia→collect(underlying)→collect(address)→toArray( )

In order to improve readability, the dot “.” operator is overloaded to act as a “collect” operation on sets (OCL feature). The expression below is equivalent to the previous one:
Rule 7: context NetworkHost: addresses:=connectedvia.underlying.address→toArray( )

It should be noted that the above examples navigate the to-one underlying relationship that may be undefined. Therefore, the expression must catch that error as shown below:
Rule 8: context NetworkHost: addresses:=connectedvia.underlying→collect(address→toArray( ) default null)

5.1.5 Relationship Assignment

The assignment operator can be used to specify the values of relationships as well as attributes. Only a single assignment may be defined for each object class relationship. Moreover, only one end-point of the relationship may be associated with an assignment rule. The OSL runtime system will not allow multiple assignments to the same relationship, or concurrent assignments to both endpoints.

To-many relationships may be assigned from arrays or collections of objects of the relationship target type. If an ordered to-many relationship (list) is assigned from a set, then the order of the elements will be arbitrary. A rule may construct a set or sequence explicitly using the special collection constructor:
Rule 9: context NetworkHost routes:=Set<IpRoute>(IpRoute(“0.0.0.0/0”, “eth0”), IpRoute(“127.0.0.0/8”, lo0”))

The set and sequence collection constructors take variable-length arguments, which are used to build the set or sequence. The order of the arguments is important in sequence declarations.

5.1.6 Object Creation

Tabular information is frequently encountered in network configuration management. Examples of common tabular configuration data include route tables, firewall rules, and name-address tables. In the typical mapping of such information to the object-relationship model, a class is defined containing the table column attributes. Instances of that class represent table rows. These may be stored in a Java array, or using an ordered, or unordered to-many relationship.

OSL rules may create objects to populate arrays or relationships. For example, consider a rule computing the route table of a network host. The “NetworkHost” object is related via the “connectedVia” relation to zero or more link interfaces. Each “LinkInteface” is used to support zero or more network interfaces. The OSL rule below sets the network host routes relationship to the set of “IpRoute” objects created for each network interface. Instances of “IpRoute” are created by invoking the class constructor.
Rule 10: context NetworkHost:routes:=connectedvia.underlying→collect (IpRoute(netmask, this))

Object creation is an additional mechanism for creating side-effects. The objects created may trigger additional rules, and require life-cycle management. The semantics of OSL rule object creation are that during every rule evaluation, all previously created objects are deleted, and new ones are created. Therefore, a rule-created object cannot exist outside the relationship in which it was defined. In practice, implementation will optimize by recycling objects, as long as this practice does not violate the aforementioned semantics.

Additionally, rule-created objects are restricted as follows:
Objects are created using an object constructor of the form: class-name “(”argument (“,” argument)* “)”
All object attributes and relationships must be specified at construction time
Object created by rules are not persisted
Object identity may change and should not be depended upon to remain stable

5.1.7 Distributing Relationship-Set Assignments

The semantics of relationship assignment state that there may be only one assignment per class relationship, and only one side of the relationship may be assigned to. In some cases, it may be more natural to express the assignment of an unordered to-many (set) relationship as a union of sets. For example, entries to the route table may be defined by the network interface object as shown below. This definition is equivalent to the example from the object creation discussion.
Rule 11: context NetworkInterface:

LayeredOver.connects.routes+=IpRoute(address, netmask)

The plus-equals (“+=”) operator is defined as a union operation on relationship sets. It is permissible to define any number of plus-equals rules on the same to-many set relationship, as long as no assignment rule has been defined. As shown in the table below, the multiple plus-equals rules are converted into a single assignment rule containing a union of all the right-hand-side expressions.

| Expression | Description |
|---|---|
| set += object | add object to set |
| set += set2 | merge sets |
| set := {object} ∪ set2 | result |

5.1.8 Let Environment

The “let” statement may be used to define local constants and functions within an OSL expression (OCL feature). The “let” statement syntax is: “let”variable {“(”parameter-list “)”} {“:”type } “=”expression “in” expression

For example, the example below defines the local constant “DEFAULT_MTU” for use within the computation.
Rule 12: context Networklnterface

mtu:=let DEFAULT_MTU=508 in DEFAULT_MTU *2

A local function may also be declared in the let environment as shown in the next example:
Rule 13: context Linklnterface:

loopback:=let isLoopback(IpAddress addr):boolean=addr=IpAddress(“127.0.0.1”)
in
   isLoopback(underlying.address)

5.1.9 Management Functions

OSL expressions may be parameterized and declared as management functions attached to a context object. This mechanism allows OSL programmers to extend the methods of a JSpoon object at runtime. Management functions may be overloaded with multiple dispatch, but may not override or overload Java methods.
Rule 14: context IpRoute:defun isLocal( ):boolean=intfc.layeredOver.loopback default false

5.1.10 Embedding Management Functions in JSpoon

OSL expressions can be statically associated with JSpoon class definitions. Assignment rules are added as a JavaDoc (See Sun Microsystems, “JavaDoc 1.4 Tool Documentation,” Tech. Rep., http://java.sun.com/j2se/javadoc/, Sun Microsystems, 2003, which is hereby incorporated by reference herein in its entirety) “@jspoon OSL:=” tag associated with the JSpoon attribute declaration. In the example below, the “active” attribute of the “Application” class is declared as a JSpoon configuration attribute. The JavaDoc JSpoon tag specifies that the value of the attribute is computed by the expression provided. At compile time, the JSpoon compiler will invoke the OSL plugin to parse the expression, and extend the “Application” class JSpoon meta-schema.
Rule 15: public class Application {
   /**@jspoon OSL:=servedBy.active default false*/config boolean active; }

Similarly, management functions may be declared as JavaDoc comments placed in the class context as shown below.
Rule 16: public class Application {
   /**@jspoon OSL defun isUp( ):boolean=. . . */}

5.2 OSL_{0.5} Propositional Expression Language

5.2.1 Conditional Operation

OSL_{0.5} extends OSL₀ with an “if-then-else” operation. Since there are no side effects in OSL expressions, the semantics are different from those of imperative languages. The if-then-else operation evaluates the “if” condition, and if it is true, it returns the result of evaluating the “then” expression, otherwise it returns the result of evaluating the “else” expression.

The OSL_{0.5} example below configures the maximum transfer unit (MTU) of a link interface based on the type of its interface. If the “loopback Linkinterface” attribute is true, then the mtu is set to 16436, otherwise it is set to 1500.
Rule 17: context LinkInterface mtu:=if loopback then 16436 else 1500

Binary Boolean Operations:The OSL₀ language is restricted in the types of operations on booleans. For example, the lack of binary boolean operators, means that rules such as “an application is active if it is enabled and its host server is active” cannot be expressed. The OSL_{0.5} language includes boolean binary operations, which are short-hands for the application of the “if-then-else” operation as shown in the following table:

| Operation | Notation | Equivalent | Result Type |
|---|---|---|---|
| and | a and b | if a then b else false | Boolean |
| or | a or b | if a then true else b | Boolean |
| xor | a xor b | if a then not b else b | Boolean |

The aforementioned rule can thus be expressed as shown in the next example:
Rule 18: context Application:active:=enabled and (servedBy.active default false)
   Switch Table Operation: When defining management change propagation rules, it is common to encounter expressions which associate values based on a table. For example, the MTU of a link interface is typically determined by its type. Although it is possible to express such tabular rules using nested “if-then-else” expressions, the OSL_{0.5}“switch” operation provides improved readability. The syntax of the operation and its semantics in terms of “if-then-else” are shown below:
   “switch” “(” int-attribute “)” {“:” type }
      “case” (int-value₁“:” expression₁ “,”)*
      “default” “:” expressionsₙ
   if (int-attribute=int-value₁) then expression₁
   else if (int-attribute=int-value₂) then expressions₂
   else expressionₙ

Using the OSL_{0.5} “switch” operation, the MTU of the link interface could be set as shown in the next example:

Rule 19: context LinkInterface mtu:=switch(type):int

| | |
|---|---|
| case LOOPBACK: | 16436, |
| case ETHER.NET: | 1500, |
| case PPP: | 576, |
| default: | 1500 |

5.3 OSL₁ First-Order Expression Language

The OSL_{0.5} language cannot express iteration over collection types, or instances of a JSpoon class. Rules such as “a network host is connected to the network if it has a network address configured over a non-loopback interface” cannot be expressed in OSL_{0.5} because one cannot iterate over the “connectedVia” relationship and select only the link interfaces whose “loopback” attribute is true.

5.3.1 Iteration

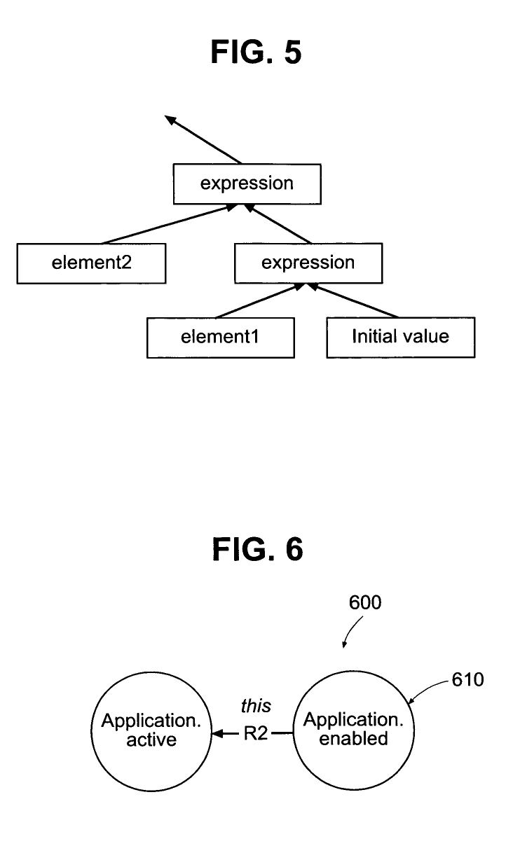

The OSL₁ language adds a first-order collection operation iteration operation. The iterate operation iterates over each element of the collection, evaluating an expression over the element and an input value. On the first iteration, the input value is provided as an expression to the operation, while in the subsequent iterations it is the result of the previous expression computation, as shown in FIG. 5. The expression evaluates to the result of the last iteration.

5.3.2 Selection

For example, consider a management function that counts the number of network interfaces configured on a host. The example below defines a management function that iterates over all host link interfaces, and counts the number of network interfaces layered over them. The counting is achieved by starting initially at zero, and adding the number of network interfaces as an accumulator.
Rule 20: context NetworkHost:

defun networkInterfaces( ):int=connectedVia→iterate(1:LinkInterface; count :int=0
   |count+1.underlying→size( ))

The “iterate” operation may be used to select objects from collections. Because selection is a common operation, OSL₁ provides explicit selection operations as listed below:

| Operation | Result | Description |
|---|---|---|
| select(bool-expr) | Collection | the elements satisfying the expression. |
| | | ≡ iterate(s: Set<Type>\|if (expression) then |
| | | Set<Type>(s, this) else s) |
| reject(bool-expr) | Collection | the elements not satisfying the expression. |
| | | ≡select(not bool-expr) |

In the next example, the “select” operation filters the elements of a set by evaluating an expression.
Rule 21: context NetworkHost:

defun isConnected( ):boolean=connectedVia→select((not loopback) and (not underlying→isEmpty( )))→size( )<>0

The iterate operation can be used to express first order for-all and exists operations, as well as numeric operations such as sum, and min as shown in the table below:

| Operation | Op. | Result | Description |
|---|---|---|---|
| forAll(bool-expr) | and | boolean | true if the expression is true for all. |
| | | | ≡iterate(a = true\|a and bool-expr) |
| exists(bool-expr) | or | boolean | true if the expression is true for one |
| | | | or more. |
| | | | ≡iterate(e = false\|e or bool-expr) |
| sum(num-expr) | + | number | sums the expression over all. |
| | | | ≡iterate(c = 0\|c + int-expr) |
| min(num-expr) | < | number | returns the minimum value in |
| | | | the collection. |
| | | | ≡iterate(min = Integer.MAX\|let v = |
| | | | int-expr in if (v < min) then v |
| | | | else min) |

### 6 Expressing Policy Constraints

Policy constraints are declarative expressions over the object-relationship model evaluating to a boolean value. Constraints are used to validate changes in the model instantiation. The navigational requirements for expressing policy constraints over an object-relationship model are very similar to those of expressing propagation rules. However, unlike propagation rules, constraints do not affect the model, and therefore there is no possibility of mutual interaction. There are two basic types of constraints:
1) invariants:expressions that must evaluate to “true” after every change has been applied and all applicable change propagation rules have been applied.
2) postconditions:expressions that must evaluate to “true” at the end of a transaction.
   The semantics of constraint evaluation are expressed below:

on (each external change to field f of object o of class c on transaction t) do
propagate changes (section 5.0.2)
for (each invariant constraint a) do:
   if (not verify(a)) abort(t)

on (transaction vote) do
for (each postcondition constraint p) do:
   if (not verify(p)) abort(t)
      In the autonomic management architecture, all model access is transactional. External changes to the model are all associated with a transaction t. Invariant evaluation is triggered by every external change, and is performed after all changes triggered have been propagated. If an invariant is found violated, then the transaction is aborted. Postconditions are evaluated when the transaction initiator has requested a transaction commit, and the transaction enters its voting state. If any postcondition has been violated by the transaction model updates, external as well as propagated changes, then the transaction is aborted.

As was the case with propagation rules, an implementation is allowed to optimize the verification of constraints based on triggering dependencies, as long as the above semantics are satisfied.

The change propagation language hierarchy was necessitated by the complexity of analyzing cyclical dependencies between rules. Policy constraints do not require such analysis, therefore OSL₁ can be used as a basis for the Object Policy Language (OPL). The general form of OPL constraints are shown below:
context class-name:constraint-type:boolean-expression
The constraint type may be either “inv,” or “post,” and the boolean expression may be any OSL₁ expression evaluating to a boolean value.

6.1 OPL Implies Operator

The “e₁ implies e₂” operator may be used to assert the truth of “y” if “x” is “true.” It is equivalent to the OSL_{0.5} statement “if (e₁) then e₂ else true,” where e₁, e₂ evaluate to a boolean value.

6.2 OPL Invariants

An OPL invariant constraint is declared as an expression specifying the “context” of the expression evaluation, the constraint type “inv,” and an expression evaluating to a boolean value. An example invariant is shown below. The invariant states that the link interfaces of a network host should only be enabled if the host's internal firewall has been enabled. The invariant restricts the order in which changes may be performed or propagated in the same transaction. Invariants typically prevent race condition in application of the effects of a transaction.
Constraint 1: context NetworkHost:inv:

ConnectedVia→forAll((enabled=true) implies firewall.enabled)

Invariants can conflict with rule-based propagation of changes. It is the responsibility of the rule programmers to assure that their rules do not violate invariants irrespective of the order applied. For example, a rule for configuring the enabled attribute of a “LinkInterface” would need to be encoded as shown in the next example to guard against violation of the constraint:
Rule 22: context LinkInterface:

enabled:=(connects.firewall.enabled default false) and (linkSignal)

6.3 OPL Postconditions

Postconditions are used to express constraints on the result of a transaction consisting of external changes as well as rule-based propagations. Unlike invariants, postconditions may be violated in the course of a transaction, but must be satisfied in the final transaction state.

A postcondition constraint example is shown below. The constraint states that in the context of an “Application” object instance, if the “enabled” attribute is set to “true,” then the application must be related to a “NetworkHost” instance through the “servedBy” relation.
Constraint 2: context Application:

inv :enabled implies not servedBy<>null

### 7 Static OSL Analysis

The semantics of the spreadsheet object-relationship model do not allow for cycles in rule evaluation. There are two basic approaches to rule cycle checking. Static rule analysis is used to determine if there is any possible model for which the rules will evaluate cyclically. The other approach is to perform cycle checking at runtime by tracking the propagation of changes over the model instantiation.

For the purposes of automation, static analysis is the preferable option since autonomic systems are expected to operate without direct human control. The discovery of cycles at runtime would require external intervention in order to analyze the nature of the cycle, and break its occurrence by removing or modifying one or more rules.

Given a Turing-complete change propagation language, such as an Event-Condition-Action system, it is not possible, in general, to statically analyze a set of rules for cyclical evaluation. This follows from the fact that it is not even possible to analyze the rules for termination (halting problem). The OR languages introduced herein, however, are not Turing-complete and therefore it is possible to perform static analysis in order to determine rule dependencies.

A formal spreadsheet model and a graph-based approach to rule analysis and incremental evaluation are presented below.

7.1 Spreadsheet Model

The semantics of spreadsheet languages are a mixture of imperative and functional semantics. A spreadsheet rule is typically of the form:
x<-expr(x₁, x₂, . . . , xₙ)
where “expr” is an expression without side-effects over the variables x₁, x₂, . . . , xₙ. Changes to the state of variables in the spreadsheet model can only be performed using the assignment operator (<-).

Consider a program language L consisting of rules in the form
y<-f(x₁, x₂, . . . , xₙ)
where y, x₁, x₂, . . . , xₙ are variables, and f is a function over the variables x₁, x₂, . . . , x ₙ.
Definition 1 (Trigger):For a rule s in L, let Trigger(s) be the set of variables appearing as triggers in the right-hand-side expression (x₁, x₂, . . . , xₙ).
Definition 2 (Target):Let Target(s) ∈ V be the right-hand-side variable of the assignment (<-) statement (y).

Note that the above definitions do not preclude the existance of a statement s ∈ L such that Target(s) ∈ Trigger(s), but require that for all s ∈ L, Trigger(s) is a set.
Definition 3 (Chain): A chain is a sequence of rules s₁, s₂, . . . , sₙ in L such that n>0 and Target (s1) ∈ Trigger(s₂), and Target(s₂) ∈ Trigger(s₃), . . . , and Target(sₙ₋₁) ∈ Trigger(sₙ). The size of a chain is the number of rules in the sequence. A chain of size one is called a trivial chain. Two chains s₁, s₂, . . . , sₙ, and t₁, t₂, . . . , tₘ are equal, if and only if, n=m and ∀1≦i ≦n:sᵢ=tᵢ.
Definition 4 (Cycle): A change propagation program is said to contain a cycle if it contains a chain s₁, s₂, . . . , sₙ, such that Target(sₙ) ∈ Trigger(s₁).

Note that it is possible to have a looping trivial chain if it contains a rule s for which Target(s) ∈ Trigger(s).
Definition 5 (Ambiguity): A change propagation program is said to have ambiguity if it contains two non-equal chains s₁, s₂, . . . , sₙ, and t₁, t₂, . . . , tₘ, such that Trigger(s₁)∩ (t₁)#NULL and Target(sₙ)=Target(tₘ)

7.1.1 Execution Model

In order to prove properties of the triggering graph, it is necessary to define the rule execution model (See A. Aiken, J. M. Hellerstein, and J. Widom, “Static analysis techniques for predicting the behavior of active database rules,” ACM Trans. Database Syst., vol. 20, no. 1, 1995, which is hereby incorporated by reference herein in its entirety). Rule evaluation is triggered by the following changes in the instance graph:
1) Attribute-set:an attribute of an existing object has been modified.
2) Relationship-set:the membership of a relationship between two objects has been modified (members added and/or removed).
3) Object-create:a new object instance has been created, resulting in the triggering of “attribute-set” on all attributes, and “relationship-set” on all object relationships.
4) Object-remove:an existing object has been removed —the effect is to remove the object from all relationships triggering “relationship-set.”

7.2 OSL₀ Triggering Graph

The spreadsheet model described in the previous section can be directly mapped into the operations of OSL₀. Given a JSpoon schema C and an OSL₀ propagation rule s ∈ S of the form “context c :t:=OSL₀-expression” then Target(s)=c.t and Trigger(s) is computed by parsing the right-hand-side expression s, and performing an in-order traversal of the tree. Based on the type of the node:
1. Attribute “a” or relationship “r”:add to Trigger(s),
2. Literal:no action performed (immutable value),
3. Operation (arithmetic, navigation, or collection):no action performed (continue recursing).
   Construction 1 (OSL₀ Triggering Graph): The triggering graph expresses the static dependencies between OSL₀ rules in the context of an object-relationship schema. If S is a set of rules in L labeled s₁ . . . sₙ, the triggering graph of S is a directed graph (digraph) G(V, E) constructed as follows:
   1) For each rule s ∈ S:
      (a) Create a graph node for Target(s)=c.a labeled “c.a” (if one does not exist)
      (b) for each variable t ∈ Trigger(s):
      (i) If t is an attribute c.a then create a graph node labeled c.a (if one does not exist), and add a directed edge c.a→t from the trigger to the target (if one does not exist) labeled “s”,
      (ii) Otherwise t is a relationship between c₁ and c₂ identified by the end-points c₁.r₁ and c₂.r₂ then create a graph node labeled “c₁.r₁:c₂.r₂” (if c₁<c₂) or “c₂.r₂:c₁.r₁” (if c₁>C₂) where classes are compared under dictionary ordering. Create a directed edge r→t from the relation node to the target node (if one does not exist) labeled “s”.
         Construction 2 (OSL₀ Triggering Graph Propagator): A triggering graph propagator is a label on a directed triggering graph edge identifying the relationship dependency path from the source to the destination node. Propagators are computed by performing an in-order traversal of each rule's right-hand-side expression and marking the relationship path traversed. Propagators are constructed as follows:
   1) For each rule s ∈ S perform an in-order traversal of the right-hand-side rule expression:
      (a) For each expression tree node, based on the type of the node:
         dot “.” and arrow “→” operations:
            evaluate left node
            evaluate right node on left node context
         name:resolve the name in the context, and add to the propagator
         binary operation:
            mark current propagator
            evaluate left node
            reset propagator
            evaluate right node
            reset propagator

7.2.1 Examples

FIG. 6 shows the result of applying the OSL₀ triggering graph construction on Rule 2. The left-hand-side 610 of R2 600 assigns the result of the right-hand-side expression to attribute “active” of class “Application.” The right-hand-side expression consists of an attribute “enabled” of the same class which generates a directed edge, labeled “R2, ” from “Application.enabled→Application.active”. The propagator is the default context “this”, since no relationships are traversed.

It should be noted that the full JSpoon class name, consisting of the package name followed by a dot “.” and the class name, is used to label the nodes. For simplicity, and without loss of generality, the examples shown do not use the JSpoon packaging capability.

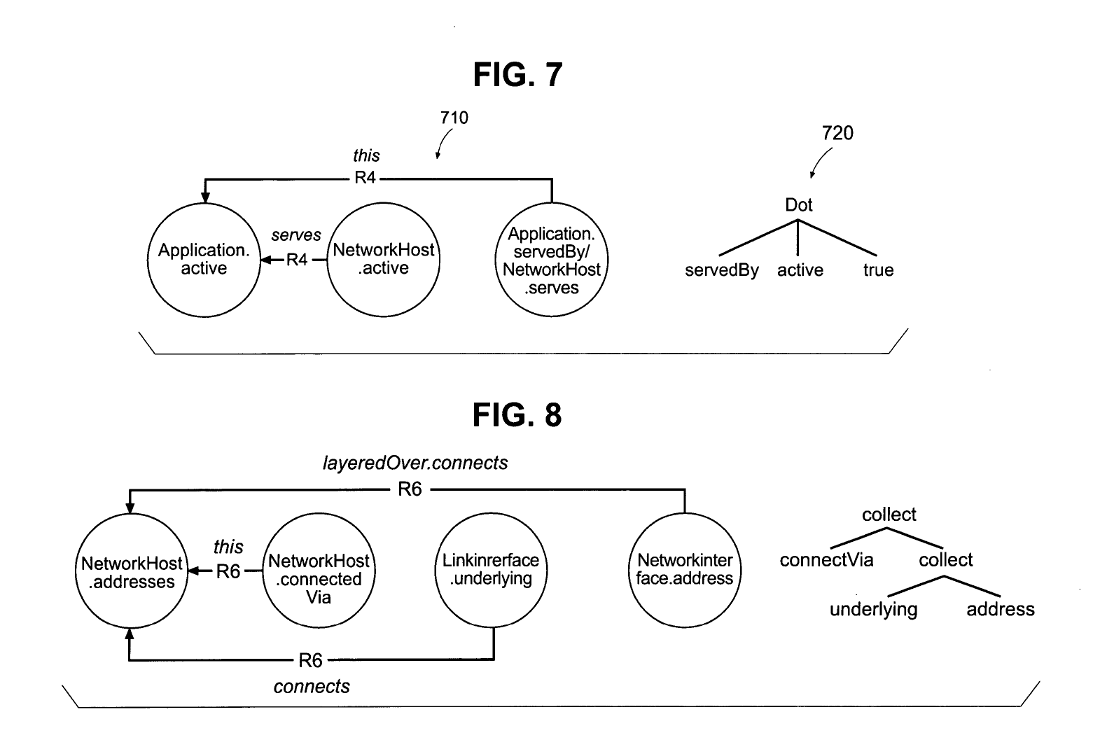

Relationship navigation establishes dependencies between the target class and the righthand-side of the propagation rule. FIG. 7 shows the graph 710 generated by Rule 4, on the left, and the parse tree 720 of the right-hand-side expression, on the right. The right-hand-side expression parses to the dot “.” operator as applied to the “servedBy” to-one relation to obtain an instance of “NetwokHost” and access the “active” attribute. The default value when the relationship is undefined is the literal (constant) “true” which cannot change and is therefore not represented in the triggering graph. The propagator on the “NetworkHost.active” property is the relationship “serves”.

The graph of a more complex OSL₀ statement using the “collect( )” operator is shown in FIG. 8. Of interest is the propagation of the “NetworkInterface.address” attribute to the “Application.active” property by navigating two consecutive relationships “layeredOver” and “connects”.

7.2.2 Trigger Graph & Propagator Algorithm

The complete traversal algorithm is listed below:

```
Context oslTrigger(Context ctx, OslTreeNode node, TriggerGraph graph)
{
  switch(node, type) {
    case PLUS:
      oslTrigger(ctx, node.left, graph);
      oslTrigger(ctx, node.right, graph);
      return(new Context (Number.class, ctx.propagator));
    // case -, *, /, =, < >
    case DOT:
      Context lc = oslTrigger(ctx, node.left , graph);
      return(oslTrigger(lc, node.right, graph));
    case ARROW:
      Context lc = oslTrigger(ctx, node.left , graph);
      switch(node.right.operation) {
        case SIZE:
          return(new Context(Integer.class, ctx.propagator));
        // ... isEmpty( ), toArray( )
        case COLLECT:
          Context mc = new Context(lc.type.memberType, lc.ctx);
          Context rc = oslTrigger(mc, node.right, graph);
          if (rc.type == Set.class)
              return(rc);
          else
            {return(new Context(Set<rc.type>.class, rc.propagator)) ;}
      }
    case NAME:
      Field field = context.type.getField(node.value);
      GraphNode source = graph.addNode(field);
      graph.addEdge(source, ctx.propagator);
      return(new Context(field.type,
              new Propagator(propagator, field);
    case LITERAL:
      return(new Context(node.type, ctx.propagator));
  }
}
```

7.3 OSL₀ Termination
Lemma 1:A set of rules in L contains a cycle, if and only if, its triggering graph contains a cycle.

Consider a set S of rules in L containing a cycle. By Definition 4, there exists a sequence of rules s₁, s₂, . . . , sₖ such that Target(s₁) ∈ Trigger(s₂), . . . , Target(sₙ₋₁) ∈ Trigger (sₙ), Target(sₙ) ∈ Trigger(s₁). By construction of the triggering graph, the set of arcs Target(s₁)→Trigger(s₂), . . . Target(sₖ)→Trigger(s₁) must exist due to the triggering dependencies. Let vᵢ be any variable vᵢ ∈ Target(sᵢ), and tᵢ=Trigger(sᵢ) where i ≦1≦k. Then the cycle v₁, t₁, v₂, . . . vₖ, tᵢ will exist.

Conversely, consider the triggering graph constructed out of a set of rules S in the spreadsheet language L. Assume that the triggering graph contains a cycle. Then there exists a vertice v₁ for which with a directed path v₁, v₂, . . . , vₖ, v₁, where k≧2 because the graph does not contain any self-loops (by construction). Let s₁, s₂, . . . , sₖ be the labels on the edges v₁→v₂, →v₂→v₃, . . . vₖ→v₁. Based on the construction, each edge indicates a triggering that is caused by a corresponding rule as shown in the table below:

| Arc | Construction | Rule |
|---|---|---|
| v₁ -> v₂ | v₂ ∈ Trigger(s₁) | s₁: v₂ = f(v₁, . . . ) |
| v₂ -> v₃ | v₃ ∈ Trigger(s₂) | s₂: v₃ = f(v₂, . . . ) |
| . | . | . |
| . | . | . |
| . | . | . |
| vₖ -> v₁ | vₖ ∈ Trigger(s₁) | sₖ: v₁ = f(vₖ, . . . ) |

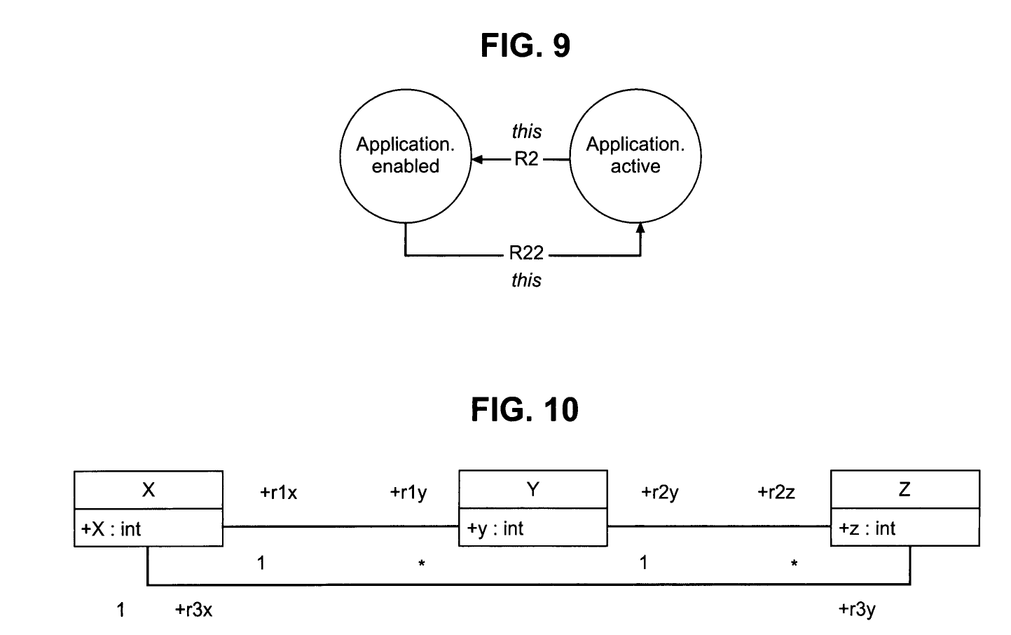

The sequence of rules represents a cycle and therefore a cycle in the triggering graph creates a cycle s₁, s₂, . . . sₖ.
Example:An example of a set of expressions whose triggering graph contains a cycle is shown in FIG. 9. The cycle is created by using Rule 2 and adding the following rule:
Rule 23: context InternetRadio:active:=enabled

Note that this particular cyclical triggering will not result in infinite execution with incremental triggering semantics. However, the behavior of assigning a value to one of the two attributes will be undefined since it depends on the order of rule evaluation.
Lemma 2: The propagation of a rule set S over an instantiation of an object-relationship schema C can cycle, if and only if, there is a cycle in the rule definitions.

Assume that a propagation cycle over instances of schema C exists. That cycle will be of the form:

$${o}_{1} {->}^{{r}_{1}} {o}_{2} {->}^{{r}_{2}} … {->}^{{r}_{n - 1}} {o}_{n} {->}^{{r}_{n}} {o}_{1}$$

where o₁. . . oₙ are object instances, and r₁. . . rₙ are relations. Let c(o) be the class of the object. Because every relation (edge) in the instance graph must also exist in the class graph, the cycle:

$$c ( {o}_{1} ) {->}^{{r}_{1}} c \text{(} {o}_{2} \text{)} {->}^{{r}_{2}} … {->}^{{r}_{n - 1}} {c ( o )}_{n} {->}^{{r}_{n}} c ( {o}_{1} )$$

must exist in the schema graph.

Conversely, if there exists a class graph cycle over the rule set S of the form:

$${c}_{1} {->}^{{r}_{1}} {c}_{2} {->}^{{r}_{2}} … {->}^{{r}_{n - 1}} {c}_{n} {->}^{{r}_{n}} {c}_{1}$$

where c₁. . . cₙ are classes, and r₁ . . . rₙ are relations, then an instance graph with a cyclical evaluation can be constructed a follows: for each class cᵢ create an instance oᵢ. For every relation, rᵢ, instantiate that relation over the two endpoint instances oⱼ and oₖ. Then the path:

$${o}_{1} {->}^{{r}_{1}} {o}_{2} {->}^{{r}_{2}} … {->}^{{r}_{n - 1}} {o}_{n} {->}^{{r}_{n}} {o}_{1}$$

must exist, which forms a cycle.
Theorem 1 (Termination): The evaluation of a change propagation program consisting of a finite set of OSL₀ change propagation rules will be finite if the program contains no cycles.

Assume that there is an infinite rule evaluation sequence s₁, s₂, s₃, . . . Let S be the set of propagation rules in the change propagation program. Because S is finite, the rule evaluation sequence will have to repeat evaluation of some rule sᵢ. The sequence from the first evaluation of the rule sᵢ to the next consists of a cycle and therefore invalidates the assumption that the rule set contains no cycles.

7.3.1 Confluence
Lemma 3 (Confluence): The order of rule evaluation of an acyclic OSL₀ change propagation program does not affect its final state.

This follows by induction on the number of rules from the fact that every variable must appear as the target of at most one rule. For n=1, the single acyclic rule r cannot trigger itself, and therefore there can only be one sequence (r) length l. Assume that the rule holds for a program of n=k acyclic rules. Consider a program of n+k acyclic rules. Assume that there exist two evaluation sequences Seq₁, and Seq₂ which terminate in different states State₁≠State₂. In that case, there is at least one variable v₁; whose value is different. Since the value of variables can only be changed through rule assignment, that variable must appear as the target of a single rule r. By the definition of propagation termination, the rule must have been evaluated in both sequences after the evaluation of its triggers. Therefore, the value may be different only because one or more of the triggering variables have different values. Because the rule set is acyclic, rule r will not be re-evaluated and therefore can be removed from the rule set. The new rule set is of size k which, from the assumption, cannot generate different states. Therefore, the assumption is invalid and the induction is proved by contradiction.

7.4 OSL₀ Evaluation
Definition 6 (Rank): The rank of a propagation rule r, Rank(r), in an acyclic change propagation program is the order of its target variable in the topological sort of its triggering graph.

Any acyclic graph can be topologically sorted in Θ(V,E) where V is the number of vertices, and E is the number of nodes (See D. E. Knuth, “The Art of Computer Programming: Fundamental Algorithms,” vol. 1. Addison-Wesley, 1973, which is hereby incorporated by reference herein in its entirety). The algorithm for efficient change rule propagation is listed below:

1 void propagate(RuleSet rules, Object source,
2 Field field, Value value) {
3 Set changed = assign(source, field, value);
4 if (changed.isEmpty( )) return;
5 SortedSet<Rule> pending = new SortedSet<Rule>(rank, ‘<’);
6 pending.add(rules.getTriggeredBy(field));
7 while(! pending.isEmpty( )) {
8 Rule rule = pending. removeFirst ( );
9 for (Object target: rule.collect(changed)) {
10 Object targetValue = oslEval(target, rule.expression);
11 Set propagated = assign(targetValue, rule.target, value2);
12 if (! propagated.isEmpty( )) {
13 pending.add(rules.getTriggered(rule.target));
14 changed.add(propagated);
15 }
16 }
17 }
18 }

The input to the algorithm is an object database odb representing the state of the object-relationship model, a triggering graph g for the acyclic change propagation program that is topologically sorted, and the variable t whose value has changed.

Given the changed variable t and the set of changed objects, originally {o}, the propagation algorithm considers all the rules which may be triggered s ∈ S:t ∈ Triggers(s) (line 5). The least ranked rule r is selected (line 8) and its triggering graph propagator is used to select the instances of the rule's target which are affected by the set of changed objects (line 9). The rule is evaluated on each instance (line 10), and if the target value has been changed, the triggered rules are added to the rule-set in rank-order (line 13), and the changed object added to the changed set (line 14). The loop continues while there are triggered rules to be evaluated.

Example:The propagation algorithm is illustrated with an example over the sample object-relationship schema of FIG. 10. The schema consists of three classes X, Y, Z, each with one integer attribute correspondingly named x, y, z. Three binary relationships r₁, r₂, r₃ connect class-pairs {X, Y}, {Y, Z}, {X, Z}.

Consider the following two rules over this example schema:
context Z:z:=(r2y.y default 0)+(r3x.x default 0)
context Y:y:=(r1x.x default 0)+1

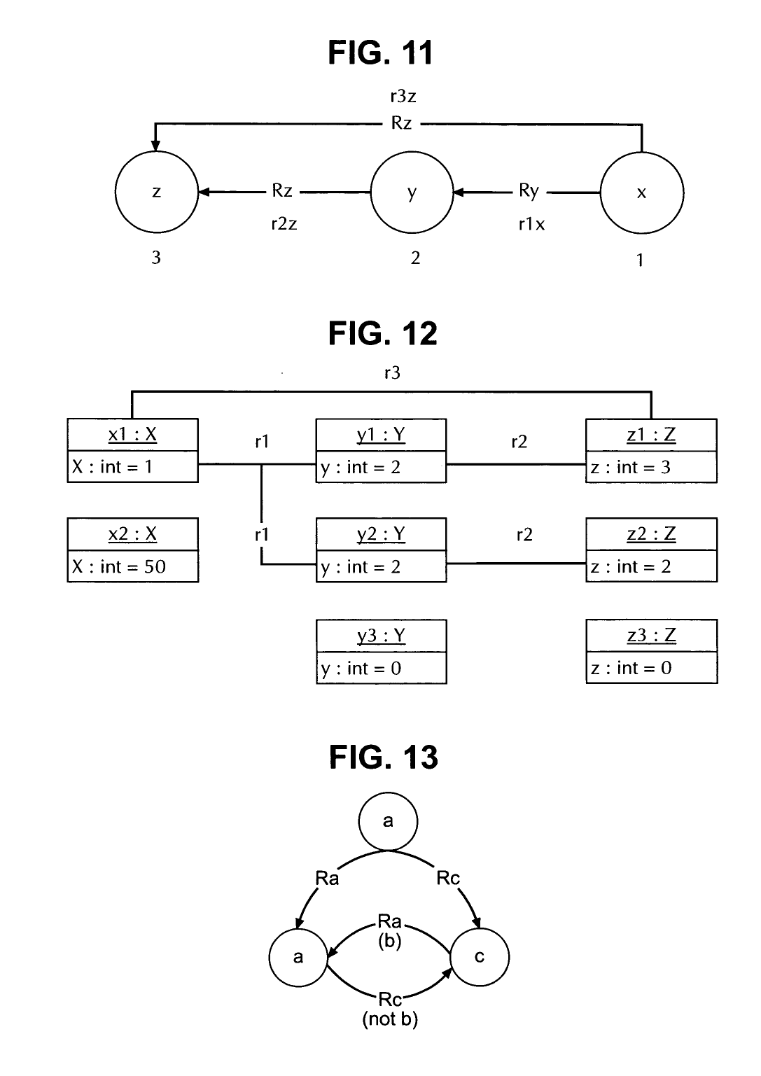

The triggering graph generated for the above two propagation rules is shown in FIG. 11 (R_{y} denotes the first rule, while R_{z} the second). As can be readily observed, the graph is acyclic, and therefore can be topologically sorted. The variable graph nodes are shown in topological order from right-to-left. The rank of propagation rules is the order of its target in the topologically sorted triggering graph, so in this case Rank(R_{y})=2 and Rank(R_{z})=3.

Consider the instantiation of the class graph shown in FIG. 12. The diagram is shown after all rules have been propagated for x=1. For example, the instance z₁ has its property z=r₂.y+r₃.x=2+1=3. Similarly, instance z₂ has its property z=r₂.y+0=2+0=2.

Consider a change in the value of attribute x of instance x1 from 1 →2 in the object database will require the potential evaluation of change propagation rules. The table below lists a trace of the propagation algorithm:

| | Pending | | | | | | | |
|---|---|---|---|---|---|---|---|---|
| Line | Rules | Modified | Rule | x₁ · x | y₁ · y | y₂ · y | z₁ · z | z₂ · z |
| | | | | 1 | 2 | 2 | 3 | 2 |
| 1 | | x₁ | | 2 | 2 | 2 | 3 | 2 |
| 6 | R_{y}(2), | x₁ | | 2 | 2 | 2 | 3 | 2 |
| | R_{z}(1) | | | | | | | |
| 8 | R_{z}(3) | x₁ | R_{y} | 2 | 2 | 2 | 3 | 2 |
| 9-14 | R_{z}(3) | x₁, y₁ | R_{y}(y₁) | 2 | 3 | 2 | 3 | 2 |
| 9-14 | R_{z}(3) | x₁, y₁, y₂ | R_{y}(y₂) | 2 | 3 | 3 | 3 | 2 |
| 8 | | x₁, y₁, y₂ | R_{z} | 2 | 3 | 3 | 3 | 2 |
| 8-14 | | x₁, y₁, | R_{z}(z₁) | 2 | 3 | 3 | 5 | 2 |
| | | y₂, z₁ | | | | | | |
| 8-14 | | x₁, y₁, | R_{z}(z₂) | 2 | 3 | 3 | 5 | 3 |
| | | y₂, z₁ | | | | | | |

The propagation algorithm is invoked with the state of the object repository, the topologically sorted triggering graph, the object affected (x₁), the attribute (x) and the value (2) changed.

In line 6, the pending rule evaluation set is initialized to the rules which are triggered from changes in X.x, which in this example are R_{y} and R_{z}. The set is sorted by the rule rank, and the least-ranked R_{y} rule is removed in step 8. The rule R_{y} is evaluated from the instances Y in x₁.r_{1y}, which are y₁, and y₂. Rule R_{y} is then applied to each instance and both values are updated. The changes in Y.y propagate to Z.z, but the rule for R_{z} is already in the pending queue. Next time through the main loop, rule R_{z} is selected (line 8), and the instances of Z in x₁.r_{3z}, y₁.r_{2z}, and y₂.r_{2z}, which are z₁ and z₂ are selected for evaluation. Note that instances x₂, y₃, and z₃ where never chosen for evaluation.

7.5 OSL₀ Propagation Complexity
Lemma 4:(Trigger Rank): Given any two rules s₁, s₂ in an acyclic propagation program, if rule s₁ triggers another rule s₂ then Rank(s₁) <Rank(s₂)

Let s₁ and s₂ be two rules in an acyclic propagation program where s₁ triggers s₂, that is Target(s₁) ∈ Trigger(s₂). Assume Rank(s₁)>Rank(s₂) then by definition of a topological sorted directed acyclic graph, there must be a directed path from Target(s₂)˜>Target(s₁). By construction of the triggering graph, every edge into Target(s₂) is constructed from the Trigger(s₂) set. Therefore, the path must be of the form v→Target(s₂)˜>Target(s₁) where v ∈ Trigger(s₂). Thus Target(s₂) ∈ Trigger(s₁), which in conjunction with the premise that Target(s₁) ∈ Trigger(s₂), creates a cycle and contradicts our assumption of acyclicity.

Let V be the number of attributes and relationships in the JSpoon schema where each binary relationship is counted once, and inherited attributes and relationships are counted again for each subclass. Let I represent the number of objects in the repository. Let S be the number of acyclic OSL₀ rules, and L the maximum number of operations in a single rule.
Lemma 5 (Rule Evaluations): Given a single change in the object-relationship model, the propagation algorithm evaluates every rule at most once, and therefore the complexity of the outer loop is O(S).

In every loop execution let s be the rule that is currently being evaluated. Based on the previous lemma, all rules which s triggers must have greater rank, and since the rule set is acyclic, a rule can only be processed once per loop. Therefore, the loop is evaluated at most S times.
Theorem 2 (OSL₀ Propagation Complexity): The worst-case performance of the change propagation algorithm is O(S.L.I). If the rule size and rule length are considered constant values, then the complexity is O(I), that is, propagation grows linearly to the number of instances in the model.

The propagation algorithm loops over the set of triggered rules sorted by rank. Given a change in variable v the set initially contains the rules s ∈ S :v ∈ Trigger(s) (line 6). While the set is not empty, the algorithm loops over, retrieving the next rule in the sorted set, evaluating its expression on every effected instance, and potentially assigning a new value to a variable v₂ and adding the statements it triggers s ∈ S :v₂ ∈ Trigger(s) into the set.

Within the loop, the complexity of retrieving the first value of a sorted set is 0(1) (line 8). The OSL₀ language does not provide any general looping constructs. Evaluating an OSL₀ expression (line 9) involves traversal of an expression tree whose complexity is O(L). The “collect( )” operation allows the collation of values from a to-many relation. In the worst case, a relationship may contain all instances of a class, thus each operation may require O(I) processing. Element membership can be established in O(1) through a space trade-off of maintaining a hash-table in addition to the tree structure. Element addition requires O(log S), but since each rule can only be added once to the set, the overall complexity of addition is O(S.log S).

Therefore, the complexity of the algorithm is O(S.L.I+S.log S). Since the number of objects will be larger than the number of rules the second term can be ignored and the complexity stated as O(S.L.I).

An example of the worst-case rule-set is shown below:
v₁:=f₁(v₂, v₃, . . . , vₙ)
v₂:=f₂(v₃, . . . (vᵥ)
. . .
vₙ₋₁:=fₙ₋₁(vₙ)
   The length of the dependency and the right-hand-side expressions can be arbitrarily long. In practice, such examples never appear in configuration management since the process would be impossible to perform manually.

7.5.1 Rule Updates

Given the set of rules S, the complexity of creating the triggering graph is the cost of parsing the expressions and adding the edges to the graph. The task can be performed incrementally, so that the cost of adding a new rules is O(Size(s)). The topological sort of the triggering graph can be computed in Θ(|M|) (See D. E. Knuth, “The Art of Computer Programming:Fundamental Algorithms,” vol. 1. Addison-Wesley, 1973, which is hereby incorporated by reference herein in its entirety).

7.6 OSL_{0.5} Analysis

The OSL_{0.5} language introduces the “if-then-else” conditional operation. The previous results on OSL₀ termination, confluence, and complexity apply to OSL_{0.5} as well. Termination is not affected because the statement does not introduce looping. Confluence is not dependent on the right-hand-side expression, rather it is dependent on the fact that only a single assignment statement is permitted per variable. The same holds for complexity, since although the statement may be used to short-circuit computation, in the worst case, the conditional expression will not be used, and the complete rule will need to be evaluated.

The main effect of the conditional operation involves the analysis of cycles in the triggering graph. It is possible to define non-trivial cycles in OSL_{0.5} which will never result in an infinite execution. For example, the following two rules form a cyclical triggering graph, but no values can satisfy the conditions leading to infinite execution.
context Example:a:=if (b) c else 1
context Example :c:=if (b) 2 else a

The triggering graph for these expressions is shown in FIG. 13. As can be readily observed, the graph contains the cycle a→c→a. In fact, the condition for the existence of the cycle is the satisfiability of the statement (b and not b), which cannot be satisfied for any value of b.

7.6.1 OSL_{0.5} Conditional Triggering Graph
Definition 7 (Phantom Cycle): An OSL_{0.5} change propagation program cycle is called a phantom cycle if there is no instantiation of schema S such that change can propagate along the cycle.
Construction 3 (OSL₀ Triggering Graph Conditional Propagator): A triggering graph conditional propagator is a propagator whose path is extended with boolean conditions. Change is propagated along each propagator relationship only if the boolean expression evaluates to “true” in the current path context. Conditional propagators are constructed by extending the propagator construction 2 with an additional case for the conditional operation, and redefining the handling of name handling:
   “if-then-else” operation
      push conditional statement into condition stack
      evaluate left node
      pop conditional statement
      push negated conditional statement into condition stack
      evaluate right node
      pop conditional statement
   name:resolve the name in the context, and add to the propagator along with the top of the conditional stack (if any).
Definition 8 (Provably Acyclic Rule Set): An OSL_{0.5} rule set is called provably acyclic if the conjunction of all conditional propagators an every triggering graph cycle is unsatisfiable.

7.6.2 OSL_{0.5} Evaluation

The OSL₀ change propagation evaluation algorithm cannot be directly applied to OSL_{0.5} due to the possible presence of cycles and the fact that a cyclic digraph cannot be topologically sorted. Since a rule may not trigger its own evaluation, in the worst case, an evaluation loop may execute Σᵢ₌₁ⁿn=O(n²) times. If the graph is topologically sorted after each cycle is broken by removing an arbitrary edge, then the average case can be improved.

7.6.3 OSL_{0.5} Complexity

Given an OSL_{0.5} triggering graph containing cycles, the analysis of the conditional propagator conjunction is at least as difficult as boolean satisfiability (SAT) which is a well know problem in NP (See S. A. Cook, “The complexity of theorem-proving procedures,” Proceedings of the third annual ACM symposium on Theory of computing, pp. 151-158, 1971, which is hereby incorporated by reference herein in its entirety). If all conditionals are conjunctive boolean expressions of variables then the problem can be solved in polynomial time. The problem of determining whether even just one single multivariate polynomial equation has an integer solution is undecidable. (See Y. V. Matiyasevich, “Hilbert's Tenth Problem,” MIT Press, 1993, which is hereby incorporated by reference herein in its entirety). If the conjunction contains linear equality equations then it can be solved in O(n³).

In practice, change propagation conditions are simple expressions, otherwise they could not have been manually enforced by human systems administrators. When computing the cycle satisfiability, an upper time limit may be placed on computation when new rules are introduced. If the time out is exceeded, the new rule will be rejected as unverifiable.

The complexity analysis for OSL_{0.5} is similar to that of OSL₀ with the difference being that, in the worst case, the outer loop may evaluate O(S₂) times and therefore the complexity of the OSL_{0.5} propagation algorithm is O(S².L.I). The algorithm continues to scale linearly with the number of objects, but the rule evaluation constant will be larger.

7.7 OSL₁ Analysis

OSL.1 introduced iteration over sets. This is a limited form of iteration which is guaranteed to terminate if the set is finite. A limited type of iteration was already available in OSL₀ in the form of the “collect” operator. Therefore, the “iterate” operator will not affect the worst-case complexity analysis.

However, the combination of the new “alllnstances” operator with the “iterate” operator allows users to perform first-order relational calculus operations. Selection, projection, union, and intersection were already shown as part of the language. A join may be performed as shown in the example below, which sets the “serves” relationship of a DNS server object to the DNS resolver objects configured to use the server's IP address:

$$context DomainNameServer \text{:}$$

$$serves \text{:} = DomainNameResolver -> allInstances \\ -> select ( r \vert r . servers -> exists ( s \vert s . address = this . address ) )$$

OSL₁ relational operation techniques can leverage the extensive research into relational database operation optimizations (See G. Graefe, “Query evaluation techniques for large databases,” ACM Computing Surveys (CSUR), vol. 25, no. 2, pp. 73-169, 1993, which is hereby incorporated by reference herein in its entirety).

### 8 Controlling Autonomic Behavior Across Domains

In the last four decades, the scale of computer networks has exploded from the order of tens of nodes in the original ARPANET, to the order of a billion of Internet nodes today. Scalability was a major challenge along the path of this growth, forcing the adoption of new protocols and management techniques. Flat-structure protocols such as the HOSTS name-to-address file were replaced by hierarchical protocols such as DNS (See P. Mockapetris, “Domain names—implementation and specifications,” Tech. Rep. RFC 1035, IETF, November 1987, which is hereby incorporated by reference herein in its entirety). Routing was also made hierarchical through adoption of inter-domain routing protocols such as BGP (See Y. Rekhter and T. Li, “A border gateway protocol 4 (BGP-4),” Tech. Rep. RFC 1771, IETF, March 1995, which is hereby incorporated by reference herein in its entirety). Human scalability was achieved by assigning the resulting hierarchical domains to network and systems management groups operating at different organization levels.

Initially, most network services operated within individual domains. Examples included file sharing, databases, local name resolution, and client-server applications. This pattern has. changed with the increasing popularity of world-wide services such as SMTP, FTP, and HTTP. In addition, the proliferation of Internet Service Providers (ISPs) has meant that many of the clients for local domain services are connected through Virtual Private Network (VPN) connections. Finally, the emerging multi-tiered web-services architectures, such as Sun J2EE and Microsoft .Net, have created new and complex dependencies between network services.

Today's reality is that that domains can no longer be isolated at the network (IP) layer, with the addition of a few isolated global distributed services such as DNS. Complex service dependencies cross existing domain structures creating reliability, optimization, and security challenges that stress the current manual management work-flows. Any approach to network element automation must therefore provide solutions that address these issues.

8.1 Inter-Domain Rule Propagation Automation

The previous section covered the analysis of propagation rules within a single administrative domain. In order for change to propagate between two domains, there must be one or more management objects that are shared by both domains. For example, a departmental domain will share the IP router interface with the organizational domain. Changes to the status of the router interface will affect the departmental domain, and may also propagate to the organizational domain.

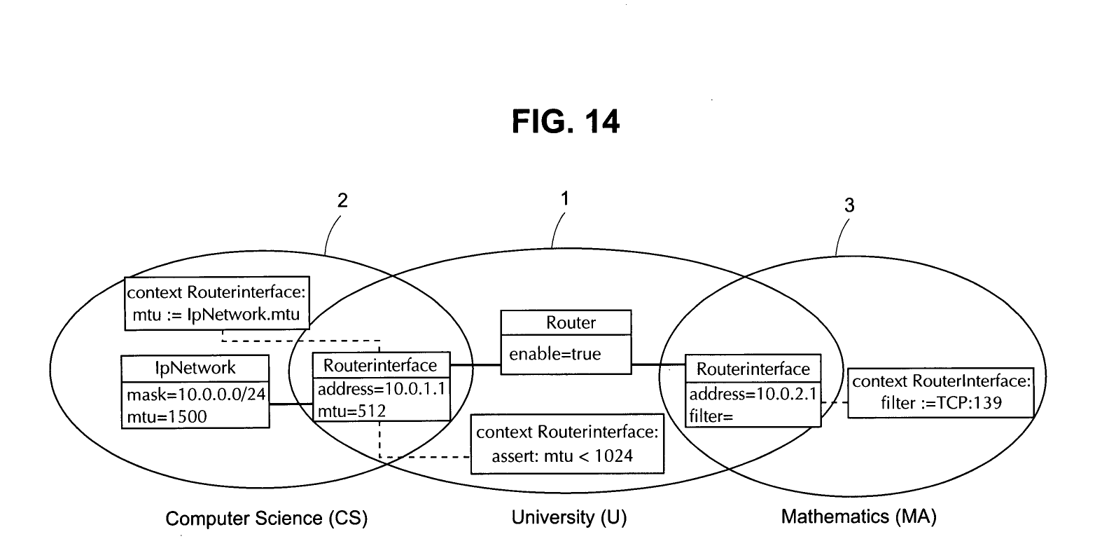

An example of such shared objects is shown in FIG. 14. The figure depicts three organizational domains representing a University (U) 1 and two of its academic departments, Computer Science (CS) 2 and Mathematics (MA) 3. Each department is responsible for its own administration. However, the management of its peering points with the University is shared with the campus network management service group.

Today, due to limitations in access and concurrency control, such “shared” resources are only jointly managed in principle. In practice, management is maintained by the service provider, and changes propagating from the client are manually propagated through some type of request ticketing system.

In order to apply the spreadsheet change propagation approach to automating inter-domain propagation, it must be possible to analyze and restrict the scope of automated propagation in a scalable manner. The simple approach of analyzing the union of all propagation domain rules is not practical because it will not scale in terms of rule evaluation. Moreover, different domains are likely to enforce different policies of their internal resources, and the union operation will result in multiple rules for the same class target. Finally, it is unlikely that domains will want to export their change rules to others, since it may expose security vulnerabilities.
Construction 4 (Summary Trigger Graph): Let S be a set of OSL propagation rules over an object-relationship schema C, and Cₑ ∈ C represent classes whose instances may be exported to other domains. If G is the triggering graph for S over C, then the summary triggering graph Gₑ for S over Cₑ is constructed as follows:
   for each node n ∈ G representing a field in a class c ∈ Cₑ add n to Gₑ
   for each node n ∈ Gₑ and for every node o ∈ Gₑ (including n) such that there is a path n ^{G}˜>o add a directed edge n ^{Ge}˜>o in Gₑ.

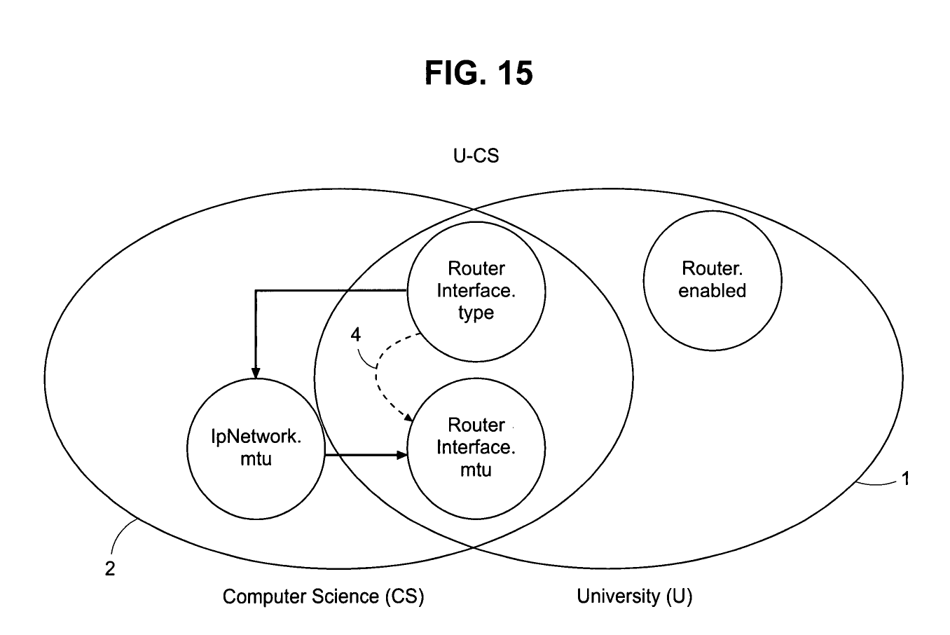

An example summary graph construction is shown FIG. 15. The example shows two domains from the previous example, CS 2 and U 1, and two attributes of the shared class “RouterInterface.” Within the CS domain, a propagation path exists from RouterInterface.type→IpNetwork.mtu→RouterInterface.mtu. Because the path spans classes that are not shared, it will be included in the summary graph as an abbreviated edge from RouterInterface.type→RouterInterface.mtu (shown as a dotted arrow 4).
Lemma 6:A triggering graph will contain a cycle containing one or more exported class attributes if and only if there is a cycle in the summary triggering graph.

Assume there is a cycle in the triggering graph containing one or more exported class attributes. The cycle can be expressed as:

$${v}_{1} {\to }^{{s}_{1}} {v}_{2} {\to }^{{s}_{2}} … {\to }^{{s}_{n - 1}} {v}_{n} {\to }^{{s}_{n}} {v}_{1}$$

where s₁. . . sₙ are class attributes or relationships and v₁ . . . vₙ are propagation rules. By the assumption, there exists an attribute or relationship si whose class c ∈ Cₑ is exported. By construction, if there are no other exported attributes or relationships in the path, then there should be a summary path from sᵢ→sᵢ. It can be easily shown by induction that this will hold for any number of exported path nodes.

If the summary triggering graph Gₑ contains a cycle, then either all path edges are in the regular triggering graph G, or the cycle contains edges which represent a path in G. Substituting the summarized edges with their G path produces a cyclical path in G.

8.1.1 Inter-Domain Cycle Analysis

Construction 5 (Shared Domain Trigerring, Graph): Given a set of propagation domains {D₁, D₂, . . . Dₙ}, let {Cₑ₁, Cₑ₂, . . . Cₑₙ) be the corresponding export schemata. Construct the summary triggering graph for pair (Dᵢ, Cₑᵢ). The shared domain triggering graph is constructed by the union of all triggering graphs.

The shared domain triggering graph is used to perform cycle analysis and to determine rule ranking that is used for rule evaluation ordering.

Thus, methods and systems for autonomously managing a network are provided. It will be apparent to one of ordinary skill in the art that although the present invention is described herein in accordance with specific embodiments, various alternate embodiments and modifications to these embodiments can be provided without departing from the spirit and scope of the invention, which is limited only by the claims which follow.

1. A method for autonomously managing a network, comprising:
automatically detecting the identity and connection of objects in the network;
binding as an object-relationship model, a plurality of rules based upon the detected identity and connection of objects in the network, wherein the rules specify how a second configuration setting is to be changed based upon at least a change in a first configuration setting;
validating the at least one rule to prevent errors when the rule is being used to change the second configuration setting; and
automatically detecting a change in at least a first configuration setting in the network, and changing at least a second configuration setting based on the object-relationship model.

2. The method of claim 1, further comprising selecting the at least one rule from a library of rules.

3. The method of claim 2, wherein selecting the at least one rule from the library of rules is based upon the object to which the rule is to be related.

4. The method of claim 1, wherein the at least one rule is implemented using a non-Turing-complete instruction set.

5. The method of claim 1, wherein the validation is performed statically at design time.

6. The method of claim 1, wherein the validation prevents loops in the at least one rule.

7. The method of claim 6, wherein the validation prevents loops in the at least one rule based upon analyzing a triggering graph.

8. The method of claim 1, wherein the validation prevents ambiguity in the at least one rule.

9. The method of claim 8, wherein the validation prevents ambiguity in the at least one rule by preventing multiple assignments to the same configuration setting.

10. The method of claim 1, further comprising reversing the change to the second configuration setting.

11. A system for autonomously managing a network, comprising:
a processor that automatically detects the identity and connection of objects in the network, binds as an object-relationship model, a plurality of rules based upon the detected identity and connection of objects in the network, wherein the rules specify how a second configuration setting is to be changed based upon at least a change in a first configuration setting, validates the at least one rule to prevent errors when the rule is being used to change the second configuration setting, and automatically detects a change in at least a first configuration setting in the network, and changes at least a second configuration setting based on the object-relationship model.

12. The system of claim 11, wherein the processor selects the at least one rule from a library of rules.

13. The system of claim 12, wherein the processor selects the at least one rule from the library of rules is based upon the object to which the rule is to be related.

14. The system of claim 11, where in the at least one rule is implemented using a non-Turing-complete instruction set.

15. The system of claim 21, wherein the validation is performed statically at design time.

16. The system of claim 21, wherein the validation prevents loops in the at least one rule.

17. The system of claim 16, wherein the validation prevents loops in the at least one rule based upon analyzing a triggering graph.

18. The system of claim 11, wherein the validation prevents ambiguity in the at least one rule.

19. The system of claim 18, wherein the validation prevents ambiguity in the at least one rule by preventing multiple assignments to the same configuration setting.

20. The system of claim 11, wherein the processor also reverses the change to the second configuration setting.
